(19) United States
(12) Patent Application Publication
(10) Pub. No.: US 2017/0262771 A1
(43) Pub. Date: Sep. 14, 2017

(54) RETRIEVAL CONTROL PROGRAM, RETRIEVAL CONTROL APPARATUS, AND RETRIEVAL CONTROL METHOD

(71) Applicant: FUJITSU LIMITED, Kawasaki-shi (JP)

(72) Inventor: Jianping Li, Yokohama (JP)

(73) Assignee: FUJITSU LIMITED, Kawasaki-shi (JP)

(21) Appl. No.: 15/435,821

(22) Filed: Feb. 17, 2017

(30) Foreign Application Priority Data
Mar. 9, 2016 (JP) 2016-045646

(51) Int. Cl. G06N 99/00; G06F 17/30

(52) U.S. Cl. CPC G06N 99/005; G06F 17/30864

(57) ABSTRACT

A non-transitory computer-readable storage medium storing therein a retrieval control program that causes a computer to execute a process includes: receiving a retrieval condition, extracting an incident corresponding to the received retrieval condition from a storage that stores an incident in association with a handling method, classifying the extracted incident in accordance with the handling method associated with the extracted incident and, outputting the classified incident as a retrieval result.

### CROSS-REFERENCE TO RELATED APPLICATION

This application is based upon and claims the benefit of priority of the prior Japanese Patent Application No. 2016-045646, filed on Mar. 9, 2016, the entire contents of which are incorporated herein by reference.

### FIELD

The present invention relates to a retrieval control program, a retrieval control apparatus, and a retrieval control method.

### BACKGROUND

A provider who provides a service to a user (hereafter also simply called provider), for example, constructs a business system in accordance with the intended use (hereafter also called information processing system), and operates the system in order to provide various services to the user. When an inquiry on a service (hereafter also called retrieval condition) is received from a user, for example, the information processing system refers to a storage unit storing events generated in the past during services provided to the user (hereafter also simply called incidents), and specifies an incident of which content is closest to the received inquiry. Then referring to the storage unit storing handling methods for incidents, the information processing system retrieves a handling method corresponding to the specified incident, for example. Then the information processing system sends the retrieved handling method to the user, for example.

Thereby the provider can allow the user to access the handling method corresponding to the inquiry received from the user (e.g. see Japanese Laid-open Patent Publication No. 2000-357175, No. 2006-92473, No. H11-219368 and No. 2003-30224).

### SUMMARY

According to an aspect of the embodiments a non-transitory computer-readable storage medium storing therein a retrieval control program that causes a computer to execute a process includes: receiving a retrieval condition, extracting an incident corresponding to the received retrieval condition from a storage that stores an incident in association with a handling method, classifying the extracted incident in accordance with the handling method associated with the extracted incident and, outputting the classified incident as a retrieval result.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting a configuration of an information processing system 10.

FIG. 2 is a diagram depicting a retrieval of a handling method.

FIG. 3 is a diagram depicting a retrieval of a handling method.

FIG. 4 is a diagram depicting the hardware configuration of the information processing apparatus 1.

FIG. 5 is a functional block diagram of the information processing apparatus 1.

FIG. 6 is a flow chart depicting an outline of a retrieval control processing according to Embodiment 1.

FIG. 7 is a diagram depicting an outline of the retrieval control processing according to Embodiment 1.

FIG. 8 is a flow chart depicting the details of the retrieval control processing according to Embodiment 1.

FIG. 9 is a flow chart depicting the details of the retrieval control processing according to Embodiment 1.

FIG. 10 is a flow chart depicting the details of the retrieval control processing according to Embodiment 1.

FIG. 11 is a drawing for describing details on the retrieval control processing according to Embodiment 1.

FIG. 12 is a drawing for describing details on the retrieval control processing according to Embodiment 1.

FIG. 13 is a drawing for describing details on the retrieval control processing according to Embodiment 1.

FIG. 14 is a drawing for describing details on the retrieval control processing according to Embodiment 1.

FIG. 15 is a table for describing an example of the first teacher data 131.

FIG. 16 is a table for describing an example of the keyword information extracted from the second handling method 131c.

FIG. 17 is a table for describing an example of the second teacher data 131.

FIG. 18 is a table for describing an example of the keyword information extracted from the second retrieval condition 131a.

FIG. 19 is a table for describing an example of the first retrieval condition 141a sent from the provider terminal 11.

FIG. 20 is a table for describing an example of the pre-conversion keyword information.

FIG. 21 is a table for describing an example of the second parameters 133.

FIG. 22 is a table for describing an example of the second correlation information.

FIG. 23 is a table for describing an example of the post-conversion keywords.

FIG. 24 is a table for describing an example of the first incidents 141b retrieved in the processing in S25.

FIG. 25 is a table for describing an example of the retrieval target data 136.

FIG. 26 is a table for describing an example of the first handling method 141c associated with the first incident 141b extracted in the processing in S25.

FIG. 27 is a table for describing an example of keywords extracted from the first handling method 141c.

FIG. 28 is a table for describing an example of the first parameters 132.

FIG. 29 is a table for describing an example of the first correlation information.

FIG. 30 is an example of the output apparatus 21 in the state of outputting the first incidents 141b.

### DESCRIPTION OF EMBODIMENTS

When the incident corresponding to the inquiry received from the user is retrieved, as mentioned above, the information processing system may extract a plurality of incidents in some cases. In this case, for example, the provider specifies an incident which seems to be closest to the content of the inquiry received from the user, out of the extracted plurality of incidents. Then, for example, the provider outputs a handling method corresponding to the specified incident to an output apparatus, by which the user can access the handling method.

However, if the number of retrieved incidents is enormous, the provider may have difficulty to specify an incident that is closest to the content of the inquiry received from the user. In this case, there is a possibility that the user is not able to access an appropriate handling method corresponding to the content of the inquiry sent by the user. The first embodiment will be explained hereinbelow.

[Configuration of Information Processing System]

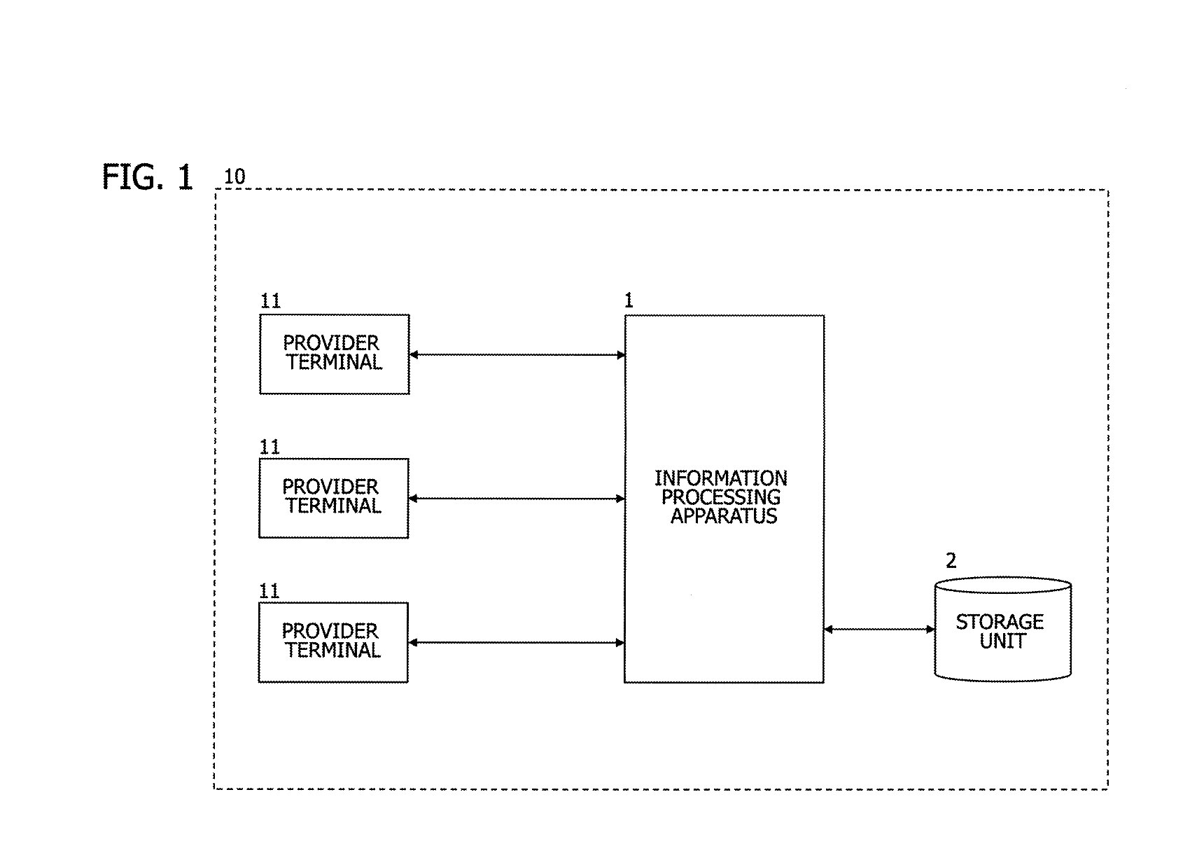

FIG. 1 is a diagram depicting a configuration of an information processing system 10. The information processing system 10 in FIG. 1 includes, for example, an information processing apparatus 1 (hereafter also called retrieval control apparatus 1), a storage unit 2, and a plurality of provider terminals 11.

When a retrieval condition is received from a provider terminal 11, which is a terminal used by a provider, the information processing apparatus 1 retrieves a handling method corresponding to the received retrieval condition. In other words, the information processing apparatus 1 retrieves a handling method corresponding to a content inquired by a user. Then the information processing apparatus 1 sends the retrieved handling method to the provider terminal 11.

The provider terminal 11 is a terminal used by the provider, and sends a retrieval condition to the information processing apparatus 1, for example. In concrete terms, the provider terminal 11 specifies a retrieval condition from the content of an e-mail (e.g. e-mail including an inquiry content for a service) sent from a user, and sends the retrieval condition to the information processing apparatus 1, for example. The provider terminal 11 also specifies a retrieval condition from a content input by an individual in charge who received a phone call from a user (e.g. content of an inquiry on a service), and sends the retrieval condition to the information processing apparatus 1, for example.

[Retrieval of Handling Method]

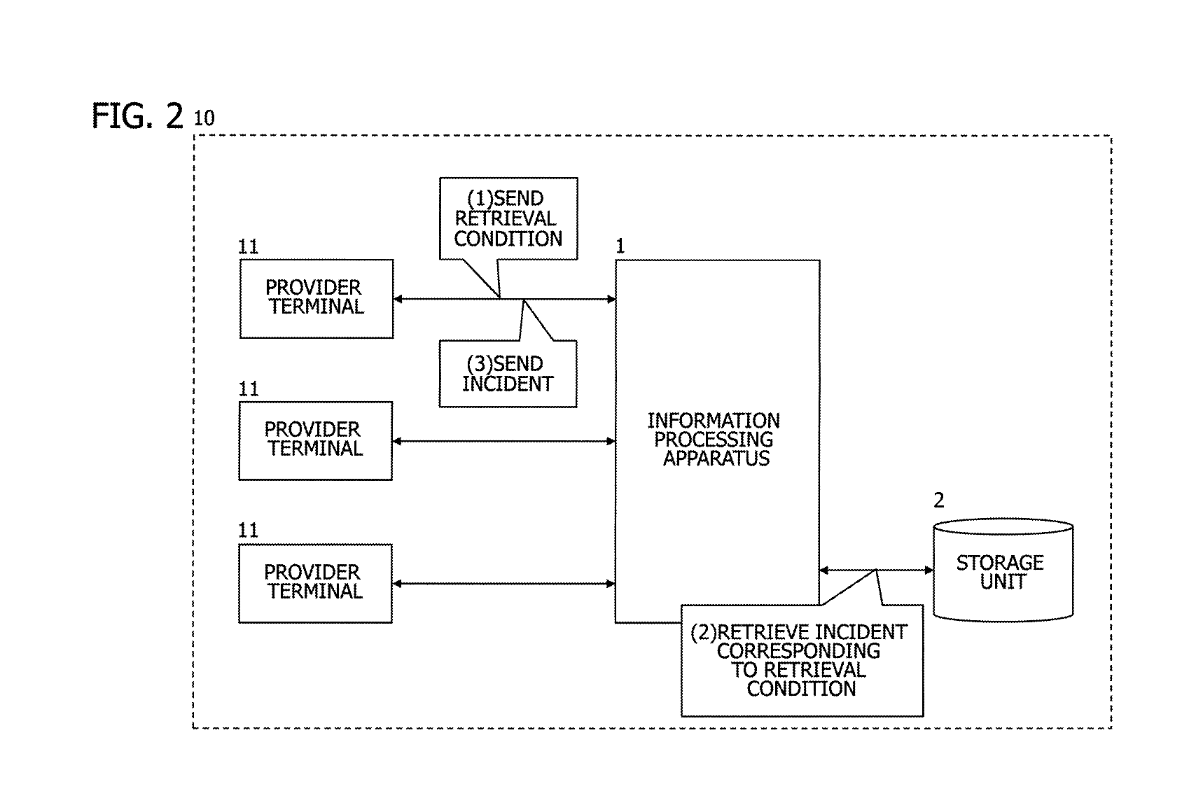

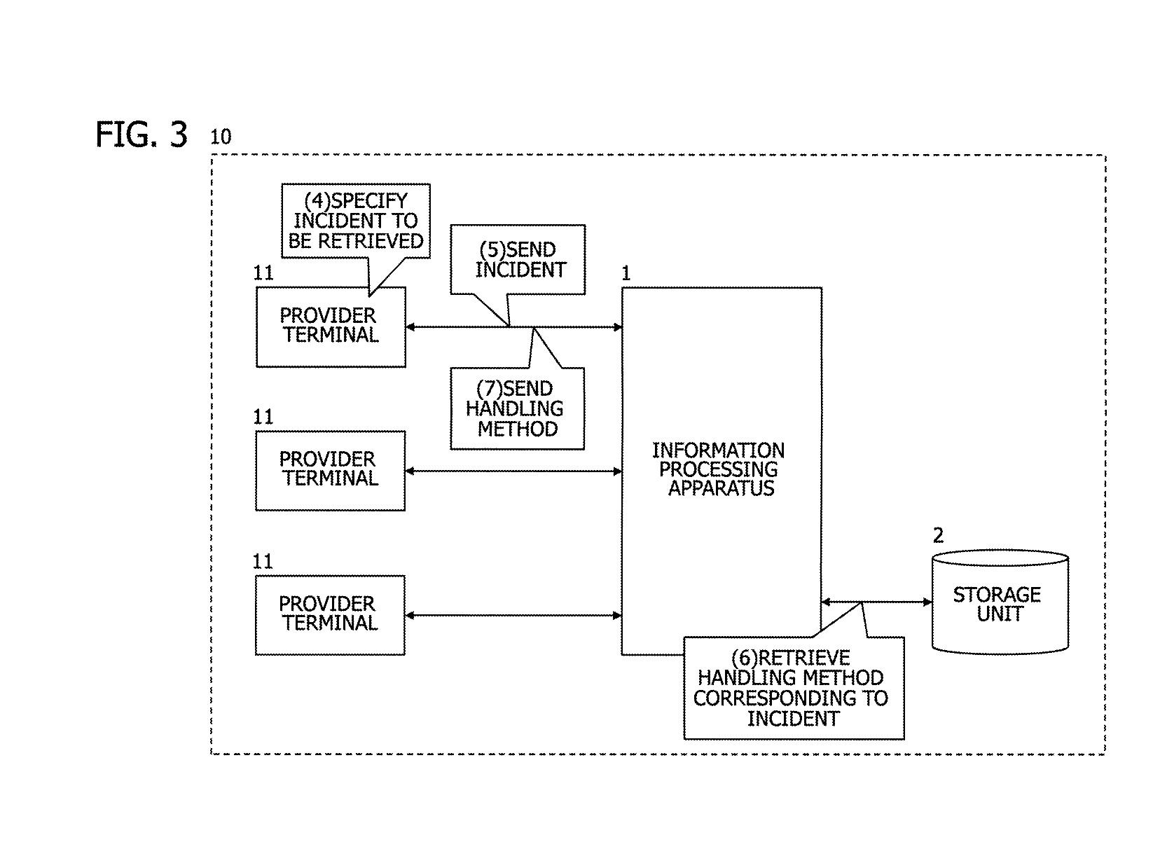

Retrieval of a handling method will be described next. FIG. 2 and FIG. 3 are diagrams depicting a retrieval of a handling method.

As depicted in FIG. 2, when the provider terminal 11 receives an e-mail sent by a user, or when an individual in charge who received a phone call from a user inputs the content of the phone call to the provider terminal 11, for example, the provider terminal 11 sends the specified retrieval condition to the information processing apparatus 1 ((1) in FIG. 2).

Then when the information processing apparatus 1 receives the retrieval condition sent by the provider terminal 11, the information processing apparatus 1 retrieves an incident corresponding to the received retrieval condition ((2) in FIG. 2). In concrete terms, when the information processing apparatus 1 receives a retrieval condition from the provider terminal 11, the information processing apparatus 1, for example, morphologically parses the sentence included in the received retrieval condition, and generates a keyword group constituted by a plurality of keywords. Then the information processing apparatus 1 accesses the storage unit 2 storing each incident corresponding to each retrieval condition, and, for example, extracts an incident(s) which includes the highest number of keywords included in the generated keyword group. Then the information processing apparatus 1 sends the retrieved incident to the provider terminal 11 ((3) in FIG. 2).

Then the provider terminal 11 specifies an incident used for retrieving a handling method from the extracted incidents, for example ((4) in FIG. 3). In concrete terms, if a plurality of incidents were extracted, the provider specifies an incident which is closest to the content of the inquiry received from the user. Then the provider terminal 11 sends the incident specified by the provider to the information processing apparatus 1 ((5) in FIG. 3)

When the information processing apparatus 1 receives the incident sent by the provider terminal 11 thereafter, the information processing apparatus 1 retrieves a handling method corresponding to the received incident ((6) in FIG. 3). In concrete terms, when the information processing apparatus 1 receives an incident from the provider terminal 11, the information processing apparatus 1 morphologically parses the sentence included in the received incident, for example, and generates a keyword group constituted by a plurality of keywords. Then the information processing apparatus 1 accesses the storage unit 2 storing each handling method corresponding to each incident, and, for example, extracts a handling method which includes the highest number of the keywords included in the generated keyword group. Furthermore, the information processing apparatus 1 sends the retrieved handling method to the provider terminal 11 ((7) in FIG. 3).

Thereby the provider terminal 11 can output the handling method sent from the information processing apparatus 1 to an output apparatus (not illustrated) which the user can access, for example. Therefore the user can access the handling method corresponding to the content of the inquiry sent to the provider terminal 11.

However, if the number of retrieved incidents is enormous in the example in FIG. 3, the provider may have difficulty to specify an incident having content closest to the inquiry received from the user. In this case, there is a possibility that the user is not able to access an appropriate handling method corresponding to the content of the inquiry that the user sent.

Therefore the information processing apparatus 1 according to this embodiment receives a retrieval condition (hereafter also called first retrieval condition), and extracts an incident corresponding to the received first retrieval condition (hereafter also called first incident) from the storage unit 2 storing incidents in association with handling methods. Then the information processing apparatus 1 classifies the extracted first incident in accordance with the handling method associated with the first incident (hereafter also called first handling method), and outputs the classified first incident as the retrieval result.

In other words, the information processing apparatus 1 according to this embodiment classifies the first incident, which was extracted based on the first retrieval condition, in accordance with the content of the first handling method associated with the first incident respectively. Then the information processing apparatus 1 sends the classified first incident to the provider terminal 11. Thereby the provider can access the first incident of the state, which is categorized in accordance with the content, from the provider terminal 11. Hence the provider can easily specify a first incident that is used for retrieving a first handling method.

[Hardware Configuration of Information Processing Apparatus]

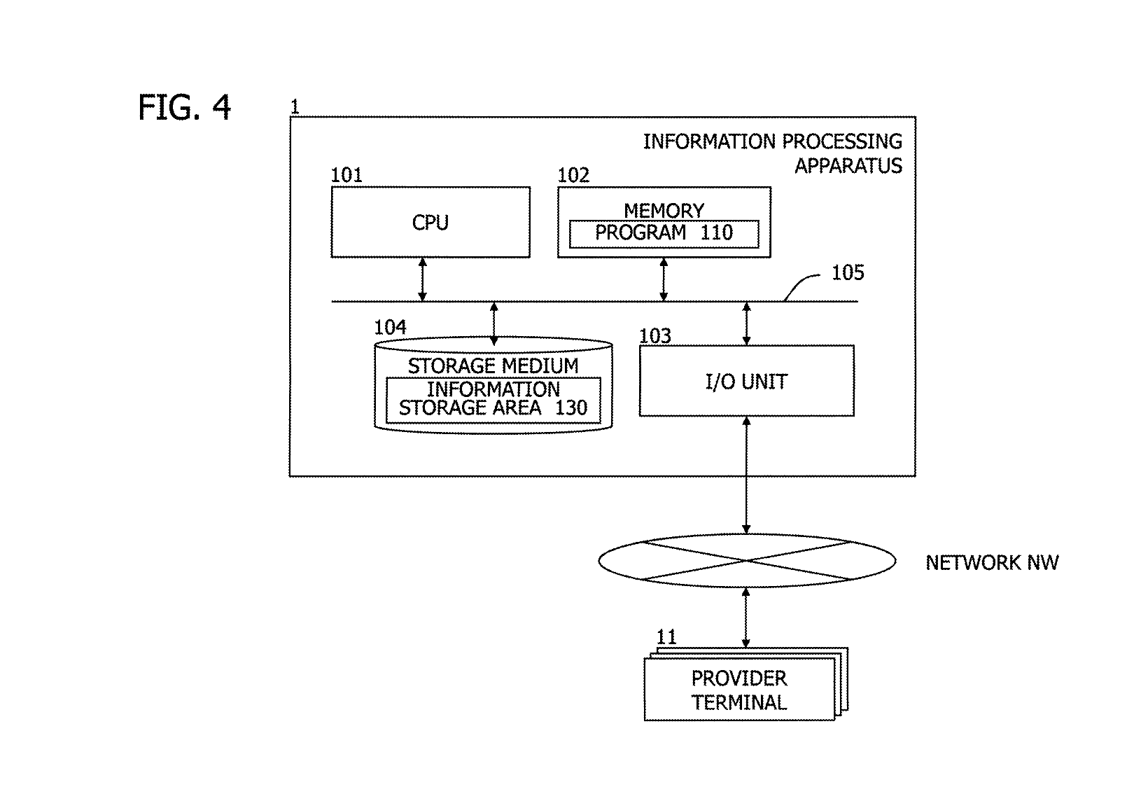

The hardware configuration of the information processing apparatus 1 will be described next. FIG. 4 is a diagram depicting the hardware configuration of the information processing apparatus 1.

The information processing apparatus 1 includes a CPU 101 which is a processor, a memory 102, an external interface (I/O unit) 103, and a storage medium 104. Each unit is interconnected via a bus 105.

The storage medium 104 stores a program 110, which executes a process to classify the first incident in accordance with the content of the first handling method (hereafter also called retrieval control processing), in a program storage area (not illustrated) within the storage medium 104. The storage medium 104 also includes an information storage area 130 in which information used for performing the retrieval control processing is stored (hereafter also called storage unit 130), for example.

As illustrated in FIG. 4, the CPU 101 loads the program 110 from the storage medium 104 to the memory 102 when the program 110 is executed, and performs the retrieval control processing in cooperation with the program 110. The external interface 103 communicates with the provider terminal 11 via a network NW constituted by an intranet, internet or the like, for example.

[Functions of Information Processing Apparatus]

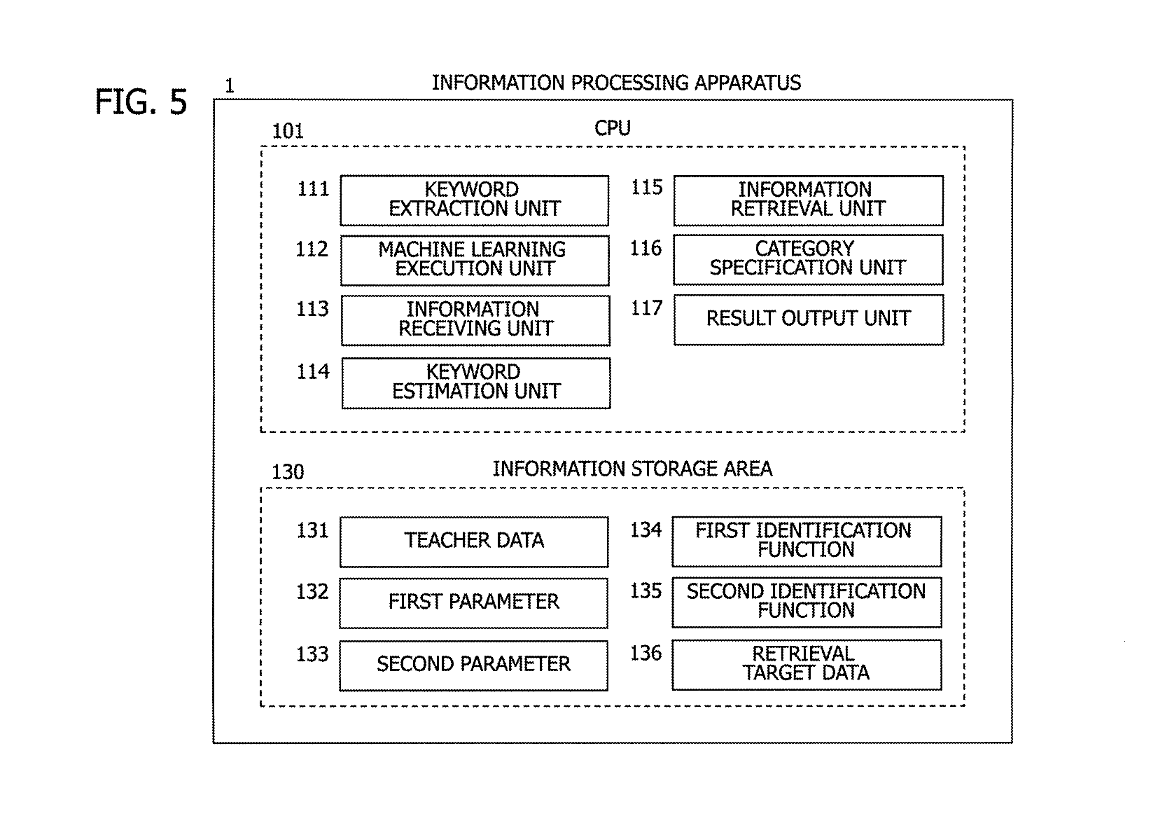

The functions of the information processing apparatus 1 will be described next. FIG. 5 is a functional block diagram of the information processing apparatus 1.

The CPU 101 of the information processing apparatus 1 operates as a keyword extraction unit 111 (hereafter also simply called extraction unit 111), a machine learning execution unit 112, an information receiving unit 113, and a keyword estimation unit 114, for example, by working in cooperation with the program 110. The CPU 101 of the information processing apparatus 1 operates as an information retrieval unit 115, a category specification unit 116, and a result output unit 117 (hereafter category specification unit 116 and result output unit 117 are also simply called output unit 117 collectively), for example, by working in cooperation with the program 110. Furthermore, in the information storage area 130, a teacher data 131, a first parameter 132 (hereafter also called classification parameter 132), a second parameter 133 (hereafter also called additional parameter 133), a first identification function 134, a second identification function 135, and a retrieval target data 136, for example, are stored.

It is assumed that the teacher data 131 includes a first teacher data 131, which includes a retrieval condition 131a (hereafter also called second retrieval condition 131a or learning retrieval condition 131a), and an additional keyword 131d. Further, it is assumed that the teacher data 131 includes a second teacher data 131, which includes a handling method 131c (hereafter also called second handling method 131c or learning handling method 131c), and a category information 131e which indicates a category of an incident corresponding to the second handling method 131c (hereafter also called second incident 131b or learning incident 131b).

Hereafter the area, in which the teacher data 131, the first parameter 132, the second parameter 133, the first identification function 134, and the second identification function 135 are stored, is also called an information storage area 130a, and the area, in which the retrieval target data 136 is stored, is also called an information storage area 130b. Further, the storage unit 2, described with reference to FIG. 1 or the like, corresponds to the information storage area 130b, for example.

The keyword extraction unit 111 extracts keywords from the second retrieval condition 131a included in the first teacher data 131, which is stored in the information storage area 130. The keyword extraction unit 111 also extracts keywords from the second handling method 131c included in the second teacher data 131, which is stored in the information storage area 130.

As mentioned later, the keyword extraction unit 111 extracts keywords from the first retrieval condition 141a before the information retrieval unit 115 retrieves the first incident 141b using the first retrieval condition 141a. Further, if the information retrieval unit 115 retrieves the first handling method 141c using the first incident 141b, as mentioned later, the keyword extraction unit 111 extracts keywords from the first handling method 141c.

The machine learning execution unit 112 machine-learns the first parameter 132 to classify the second incident 131b, associated with the second handling method 131c, into a plurality of categories, based on the keywords which the keyword extraction unit 111 extracted from the second handling method 131c.

In concrete terms, the machine learning execution unit 112 inputs the keywords extracted from the second handling method 131c and the category information 131e of the second incident 131b to the first identification function 134 as the learning data, and calculates the first parameter 132, for example. The first identification function 134 is a function that outputs the category information 131e of the second incident 131b when the keywords extracted from the second handling method 131c and the first parameter 132 are input, for example. Then the machine learning execution unit 112 machine-learns each of the first parameters in the relationship between the keywords extracted from the second handling method 131c and the category information 131e of the second incident 131b.

In other words, every time the learning data is input to the first identification function 134, the machine learning execution unit 112 adjusts the first parameter 132, so that the first identification function 134 is established not only for the learning data which was input in the past, but also for the newly input learning data. Thereby the machine learning execution unit 112 can increase the accuracy of the first parameter 132 every time the learning data is input to the first identification function 134. As a result, the category specification unit 116 can estimate and output the category of the first incident 141b, even if a keyword, which has not yet been machine-learned, is included in the keywords extracted from the first handling method 141c by the generalization function of the machine learning.

The machine learning execution unit 112 also machine-learns the second parameter 133, to convert the keywords extracted from the second retrieval condition 131a. In other words, the keyword estimation unit 114 converts the keywords extracted from the first retrieval condition 141a in order to increase the retrieval accuracy of the first incident 141b when the first incident 141b is retrieved, as mentioned later. Therefore the machine learning execution unit 112 machine-learns the second parameter 133 to convert the keywords extracted from the first retrieval condition 141a.

In concrete terms, the machine learning execution unit 112 inputs the keywords extracted from the second retrieval condition 131a and the additional keywords 131d corresponding to the second retrieval condition 131a included in the second teacher data 131 to the second identification function 135 as the learning data, and calculates the second parameter 133, for example. The additional keywords 131d are keywords which are added when the first incident 141b is searched, in order to increase the retrieval accuracy of the first incident 141b. The second identification function 135 is a function to output the additional keywords 131d corresponding to the second retrieval condition 131a when the keywords extracted from the second retrieval condition 131a and the second parameter 133 are input, for example. Then the machine learning execution unit 112 machine-learns each of the second parameters in the relationship between the additional keywords extracted from the second retrieval condition 131a and the additional keywords 131d corresponding to the second retrieval condition 131a, for example.

In other words, every time the learning data is input to the second identification function 135, the machine learning execution unit 112 adjusts the second parameter 133, so that the second identification function 135 is established not only for the learning data which was input in the past, but also for the newly input learning data. Thereby the machine learning execution unit 112 can increase the accuracy of the second parameter 133 every time the learning data is input to the second identification function 135. As a result, the keyword estimation unit 114 can estimate and output the keywords to be added when the first incident 141b is searched, even if a keyword, which has not yet been machine-learned, is included in the keywords extracted from the first retrieval condition 141a by the generalization function of the machine learning.

The machine learning execution unit 112 may operate according to such an algorithm as adaptive regularization of weight vectors (AROW), confidence weighted (CW) or soft confidence weighted (SCW) learning. The first identification function 134 and the second identification function 135 may be determined by the algorithm which the machine learning execution unit 112 uses.

The information receiving unit 113 receives the first retrieval condition 141a which is a new retrieval condition sent by the provider terminal 11.

The keyword estimation unit 114 converts the keywords extracted from the first retrieval condition 141a (hereafter also called pre-conversion keywords) by using the machine-learned second parameter 133, and acquires new keywords (hereafter all called post-conversion keywords). In concrete terms, the keyword estimation unit 114 inputs the pre-conversion keywords and the second parameter 133 to the second identification function 135, and acquires the output keywords as post-conversion keywords.

The information retrieval unit 115 retrieves the first incident 141b corresponding to the first retrieval condition 141a by using the post-conversion keywords acquired by the keyword estimation unit 114. In concrete terms, the information retrieval unit 115 retrieves the first incident 141b from the retrieval target data 136, including a plurality of first incidents 141b which the provider prepared in advance. The retrieval target data 136 may include an incident which is the same as the second incident 131b included in the teacher data 131, for example.

The information retrieval unit 115 may retrieve the first incident 141b by using only a part of the post-conversion keywords acquired by the keyword estimation unit 114. In concrete terms, the information retrieval unit 115 may extract only those keywords having a predetermined threshold or higher priority, out of the post-conversion keywords, and use those keywords for retrieving the first incident 141b, for example.

The provider may determine a number of keywords to be used for retrieving the first incident 141b in advance. Then, out of the post-conversion keywords, the information retrieval unit 115 may determine a keywords to be used for retrieving the first incident 141b in sequence from the higher priority, for example.

If a plurality of first incidents 141b are retrieved, the category specification unit 116 classifies each first incident 141b into one of a plurality of categories based on the keywords extracted from the first handling method 141c corresponding to each first incident 141b respectively by using the machine-learned first parameter 132. In concrete terms, the category specification unit 116 inputs the keywords extracted from the first handling method 141c and the first parameter 132 to the first identification function 134, and specifies the category indicated by the output category information 131e as the category of the first incident 141b. Thereby the provider can access the incidents categorized in accordance with the content in the provider terminal 11. As a result, the provider can easily specify an incident to be used for retrieving the handling method.

Then using the first incident 141b specified by the provider to receive the first handling method 141c, the information retrieval unit 115 retrieves the first handling method 141c corresponding to the first incident 141b. In concrete terms, the information retrieval unit 115 retrieves the first handling method 141c corresponding to the first incident 141b from the retrieval target data 136, including a plurality of first handling methods 141c prepared by the provider in advance.

The result output unit 117 transmits the first handling method 141c, which was retrieved by the information retrieval unit 115, to the provider terminal 11. Then the provider terminal 11 outputs the received first handling method 141c to the output apparatus (an output operation in which the user can access the information), for example.

### Embodiment 1

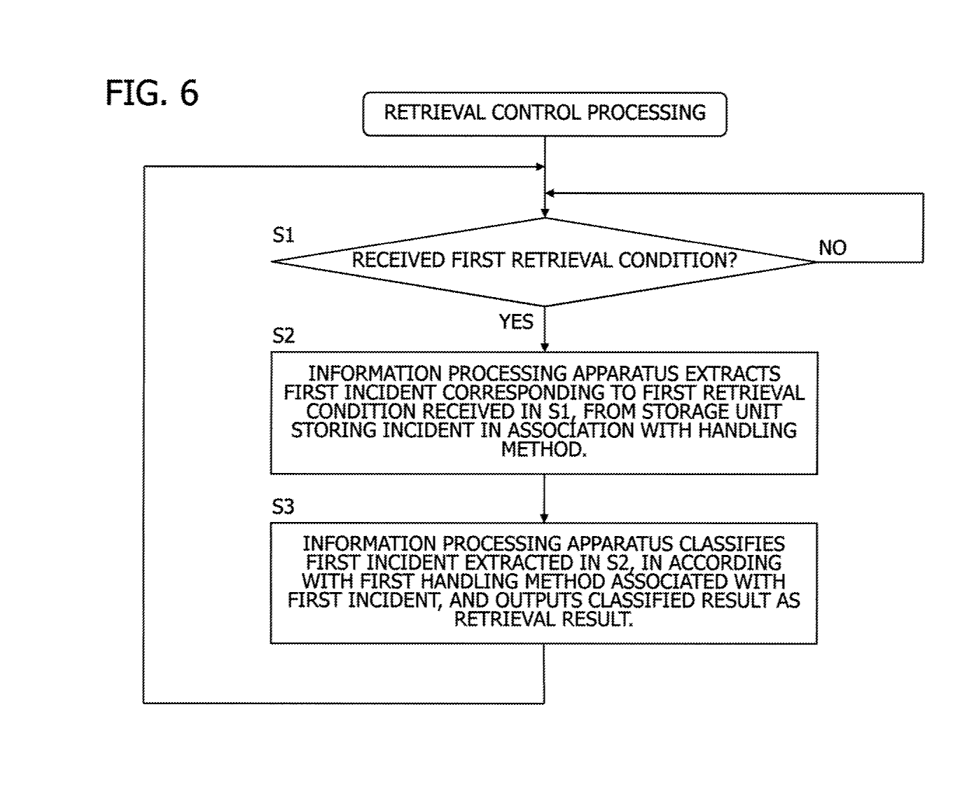

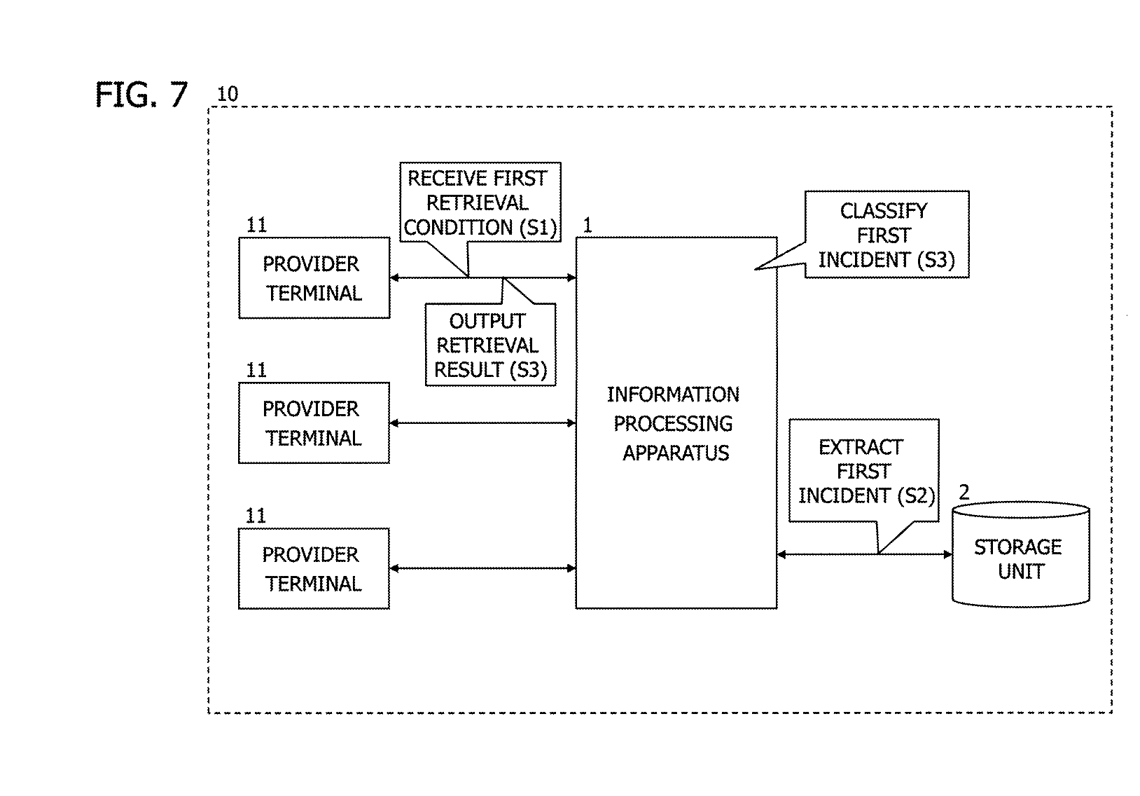

Embodiment 1 will be described next. FIG. 6 is a flow chart depicting an outline of a retrieval control processing according to Embodiment 1. FIG. 7 is a diagram depicting an outline of the retrieval control processing according to Embodiment 1. The outline of the retrieval control processing in FIG. 6 will be described with reference to FIG. 7.

As depicted in FIG. 7, the information processing apparatus 1 stands by until a first retrieval condition 141a is received from a provider terminal 11 (NO in S1). When the first retrieval condition 141a is received (YES in S1), the information processing apparatus 1 extracts a first incident 141b corresponding to the first retrieval condition 141a, which was received in the processing in S1, from an information storage area 130, in which an incident and a handling method are stored in association with each other (S2).

In other words, in the processing in S2, the information processing apparatus 1 extracts one or more first incident(s) 141b that satisfy the content of the inquiry (first retrieval condition 141a), which the user sent to the provider terminal 11, for example.

Then the information processing apparatus 1 classifies the first incidents 141b extracted in the processing in S2, in accordance with the first handling method 141c associated with the first incident(s) 141b, and outputs the classified first incident(s) 141b as the retrieval result (S3).

In other words, the information processing apparatus 1 classifies the first incident(s) 141b, which were extracted based on the first retrieval condition 141a, in accordance with the content of the first handling method 141c corresponding to each of the first incidents 141b. Then the information processing apparatus 1 sends the classified first incident(s) 141b to the provider terminal 11. Thereby the provider can access the first incident(s) 141b, categorized in accordance with the content, in the provider terminal 11. As a result, the provider can easily specify a first incident 141b to be used for retrieval of the first handling method 141c.

In this way, the information processing apparatus 1 according to this embodiment receives the first retrieval condition 141a, extracts the first incident(s) 141b corresponding to the received first retrieval condition 141a from the storage unit 130 storing each incident in association with a handling method, classifies the extracted first incident(s) 141b in accordance with the first handling method 141c associated with the first incident(s) 141b, and outputs the classified first incident(s) 141b as the retrieval result.

Thereby the provider can access the first incident(s) 141b, which are categorized in accordance with the content, in the provider terminal 11. As a result, the provider can easily specify the first incident 141b to be used for retrieving the first handling method 141c.

### Details of Embodiment 1

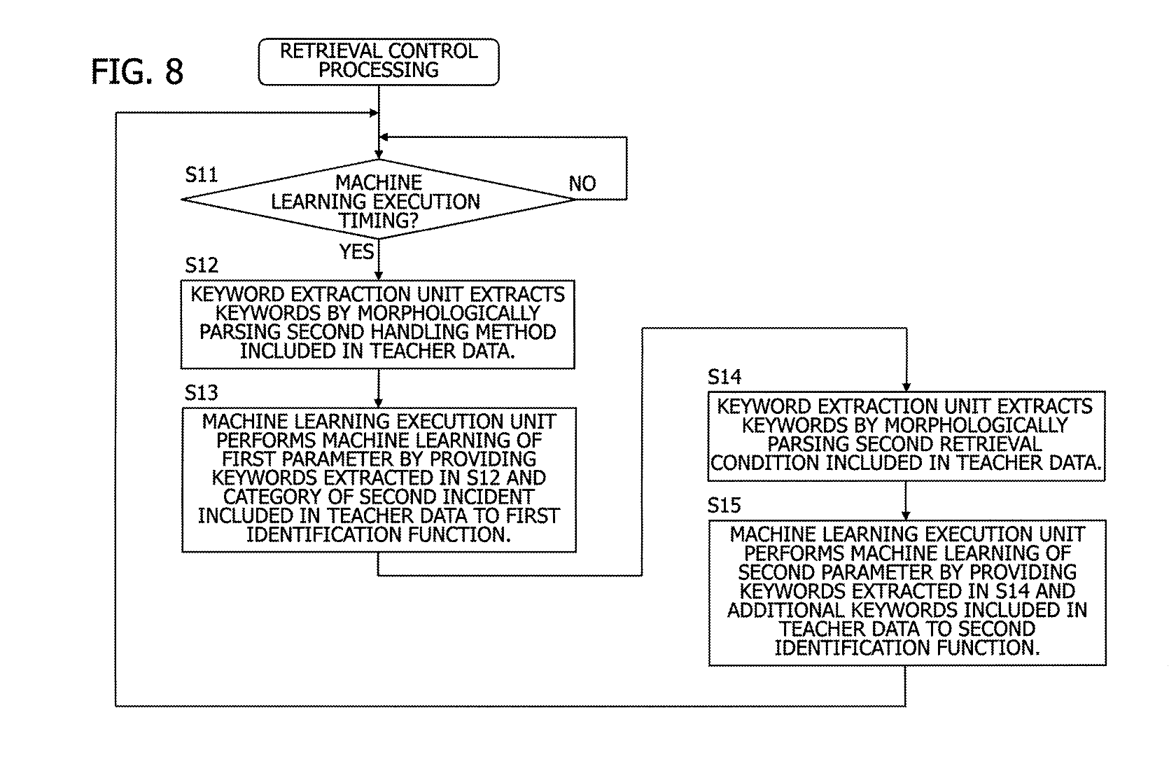

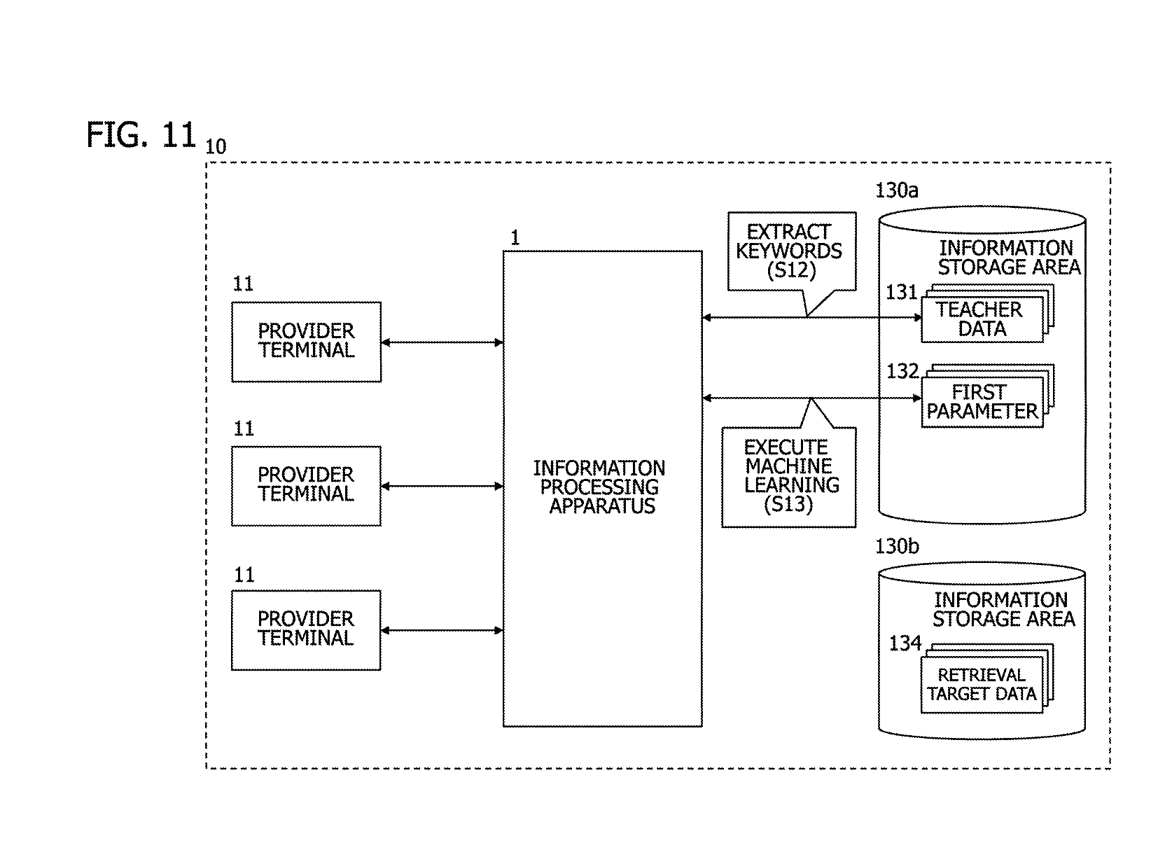

Details on Embodiment 1 will be described next. FIG. 8 to FIG. 10 are flow charts depicting the details of the retrieval control processing according to Embodiment 1. FIG. 11 to FIG. 30 are drawings for describing details on the retrieval control processing according to Embodiment 1. Details of the retrieval control processing depicted in FIG. 8 to FIG. 10 will be described with reference to FIG. 11 to FIG. 30.

As depicted in FIG. 8, the keyword extraction unit 111 of the information processing apparatus 1 stands by until the machine learning execution timing arrives (NO in S11). The machine learning execution timing is, for example, a timing when the provider performs machine learning of the teacher data 131. In concrete terms, the machine learning execution timing may be, for example, a timing when the provider input notification that the machine learning of the teacher data 131 is performed.

When the machine learning execution timing arrives (YES in S11), the keyword extraction unit 111 extracts keywords from the second handling method 131c included in the first teacher data 131, as depicted in FIG. 11 (S12). In concrete terms, the keyword extraction unit 111 extracts the keywords by morphologically parsing the second handling method 131c, for example. An example of the first teacher data 131 and an example of the extracted keywords will be described herein below.

[Example of First Teacher Data]

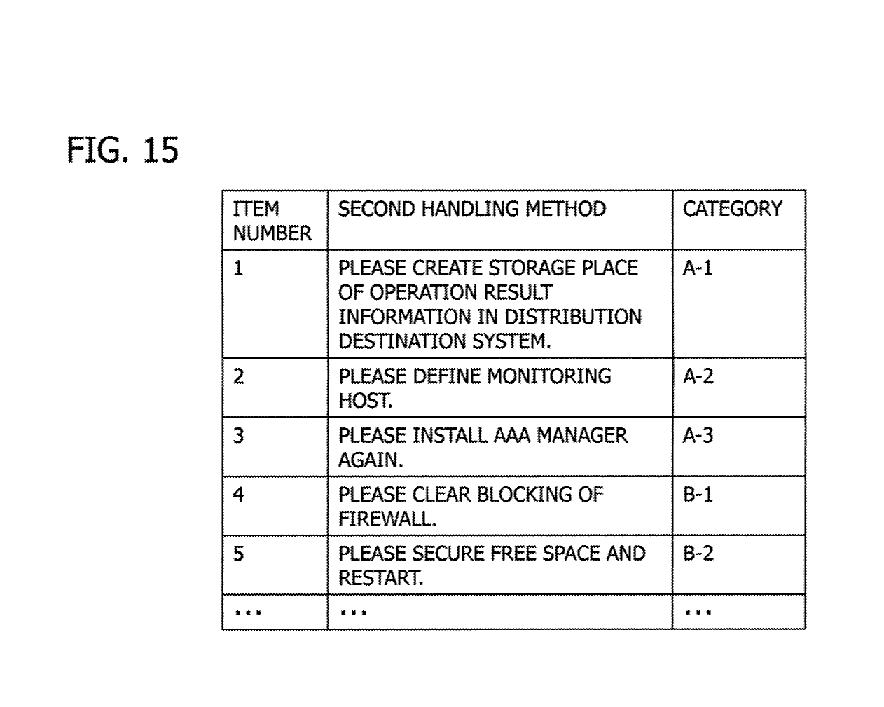

FIG. 15 is a table for describing an example of the first teacher data 131. As items, the first teacher data 131 in FIG. 15 has: “Item number” to identify each information included in the first teacher data 131; and “Second handling method”, in which a second handling method 131c is set. Further, the first teacher data 131 in FIG. 15 has an item of “Category”, in which category information 131e of the second incident 131b corresponding to the second handling method 131c being set in “Second handling method” is set.

In concrete terms, according to the example in FIG. 15, a sentence “Please create storage place of operation result information in distribution destination system.” is set in “Second handling method” of the information of which “Item number” is “1”, and “A-1” is set in “Category”. Further, according to the example in FIG. 15, a sentence “Please define monitoring host.” is set in “Second handling method” of the information of which “Item number” is “2”, and “A-2” is set in “Category”. Description on the other information included in FIG. 15 will be omitted.

[Example of Keywords Extracted from Second Handling Method]

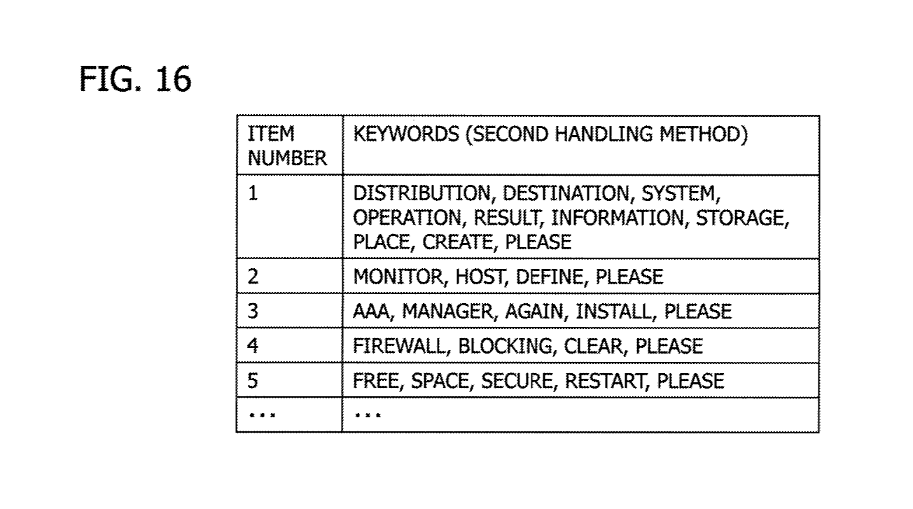

An example of keywords (hereafter also called keyword information) extracted from the second handling method 131c will be described next. FIG. 16 is a table for describing an example of the keyword information extracted from the second handling method 131c.

As items, the keyword information in FIG. 16 has: “Item number” to identify each information included in the keyword information in FIG. 16; and “Keywords (Second handling method)” in which keywords extracted from the second handling method 131c are set.

In concrete terms, according to the keyword information in FIG. 16, in the information of which “Item number” is “1”, “distribution”, “destination”, “system”, “operation”, “result”, “information”, “storage”, “place”, “create” and “please” are set as “Keywords (Second handling method)”. Description on the other information included in FIG. 16 will be omitted.

Referring back to FIG. 8, the machine learning execution unit 112 of the information processing apparatus 1 performs machine learning of the first parameter 132 by providing the keywords extracted in the processing in S12 and the category information 131e of the second incident 131b included in the first teacher data 131 to the first identification function 134 (S13).

In concrete terms, the machine learning execution unit 112 specifies the keywords which are set in “Keywords (Second handling method)” of the information of which “Item number” is “1” in the keyword information described in FIG. 16, for example. The machine learning execution unit 112 also specifies “A-1” which is set in “Category” of the information of which “Item number” is “1” in the first teacher data 131 described in FIG. 15, for example. Then the machine learning execution unit 112 calculates the first parameter 132 by inputting each of the specified information to the first identification function 134 as the learning data, and performs machine learning of the calculated first parameter 132.

Then the machine learning execution unit 112 performs machine learning by calculating the first parameter 132 for the other information that is set in “Keywords (Second handling method)” of the keyword information in FIG. 16, and for the other information that is set in “Category” of the first teacher data 131 in FIG. 15.

In other words, the machine learning execution unit 112 adjusts the first parameter 132 every time the learning data is input to the first identification function 134, so that the first identification function 134 is established not only for the learning data which was input in the past, but also for the newly input learning data. Thereby the machine learning execution unit 112 can increase the accuracy of the first parameter 132 every time the learning data is input to the first identification function 134. An example of the first parameter 132 will be described later.

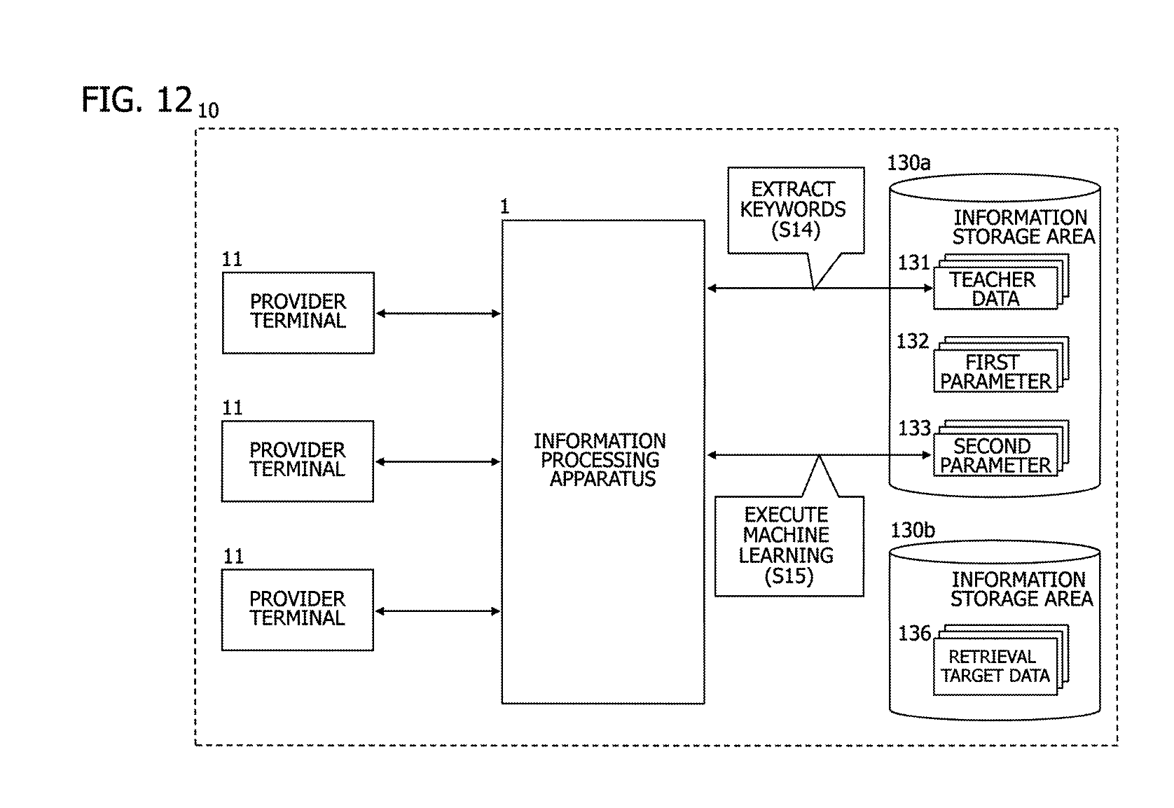

Then the keyword extraction unit 111 extracts keywords from the second retrieval condition 131a included in the second teacher data 131 (S14), as depicted in FIG. 12. In concrete terms, the keyword extraction unit 111 extracts keywords by performing morphological parsing of the second retrieval condition 131a, for example. An example of the second teacher data 131 and an example of the extracted keywords will be described next.

[Example of Second Teacher Data]

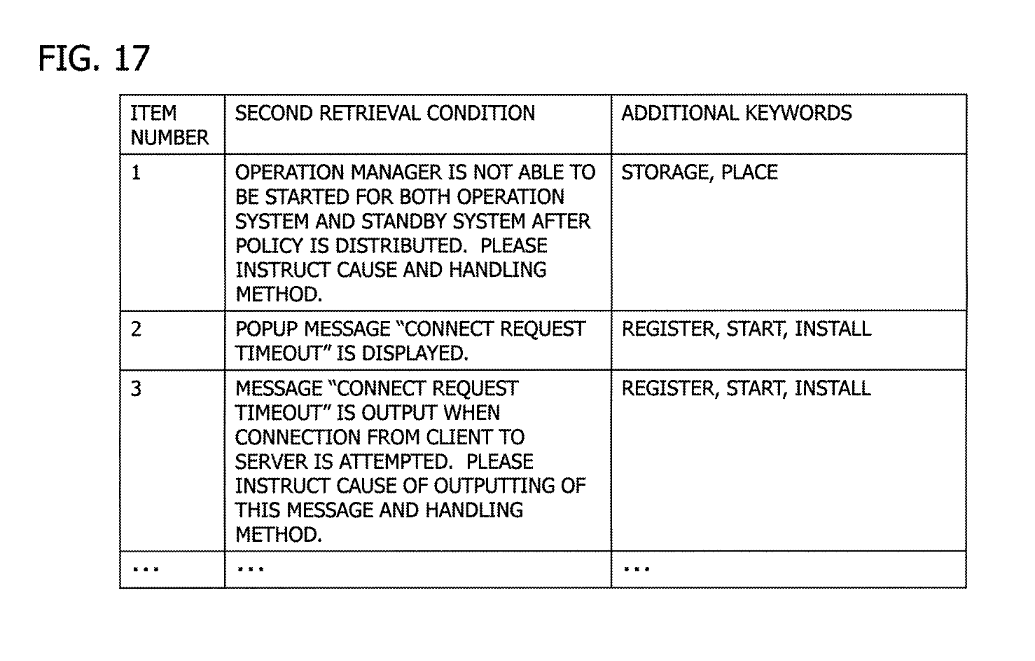

FIG. 17 is a table for describing an example of the second teacher data 131. As items, the second teacher data 131 in FIG. 17 has: “Item number” to identify each information included in the second teacher data 131; “Second retrieval condition” in which the second retrieval condition 131a is set; and “Additional keywords” in which additional keywords 131d are set.

The additional keywords 131d may be extracted from the second handling method 131c which the provider determines as desirable to retrieve for the second retrieval condition 131a. In concrete terms, as the additional keywords 131d, the provider may specify keywords which are not included in the keywords extracted from the second retrieval condition 131a, out of the keywords extracted from the second handling method 131c which the provider determined as desirable to retrieve, and include these keywords in the second teacher data 131.

In concrete terms, according to the example in FIG. 17, in “Second retrieval condition” in the information of which “Item number” is “1”, sentences “Operation manager is not able to be started for both operation system and standby system after policy is distributed. Please instruct cause and handling method.” are set. Further, according to the example in FIG. 17, “storage” and “place” are set in “Additional keywords” in the information of which “Item number” is “1”. Description on the other information included in FIG. 17 will be omitted.

[Example of Keywords Extracted from Second Retrieval Condition]

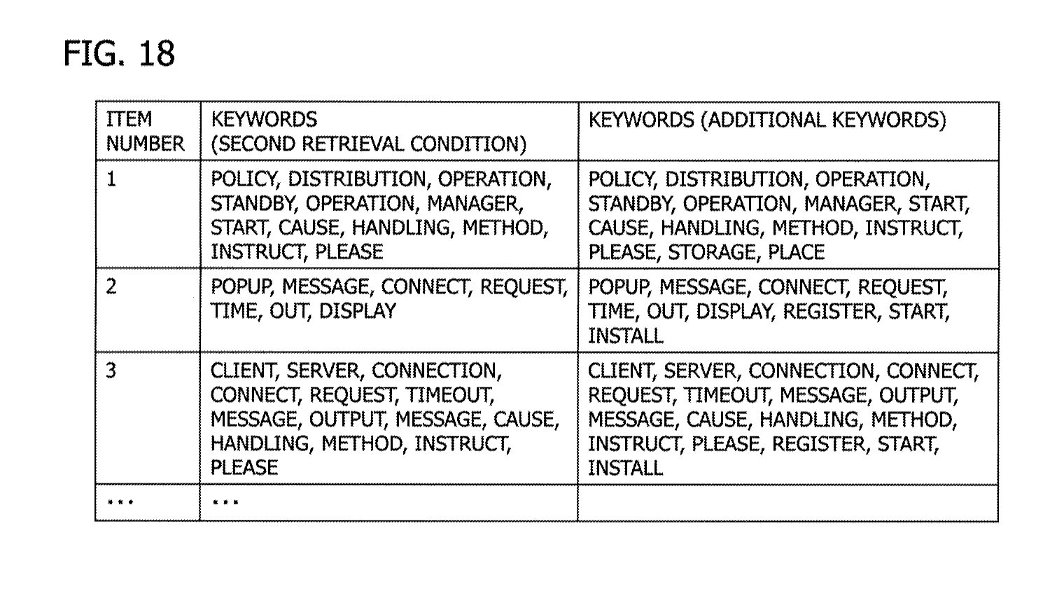

Examples of keywords (hereafter also called keyword information) extracted from the second retrieval condition 131a will be described next. FIG. 18 is a table for describing an example of the keyword information extracted from the second retrieval condition 131a.

As items, the keyword information in FIG. 18 has: “Item number” to identify each information included in the keyword information in FIG. 18; and “Keywords (Second retrieval condition)” in which keywords extracted from the second retrieval condition 131a are set. Further, the keyword information in FIG. 18 has “Keywords (Additional keywords)”, in which additional keywords are added to the keywords extracted from the second retrieval condition 131a. In other words, in the case of the example in FIG. 18, machine learning of the second parameter 133 is performed based on the keywords extracted from the second retrieval condition 131a and on the keywords in which the additional keywords are added to the keywords extracted from the second retrieval condition 131a.

In concrete terms, according to the keyword information in FIG. 18, in the information of which “Item number” is “1”, “policy”, “distribution”, “operation”, “standby”, “operation”, “manager”, “start”, “cause”, “handling”, “instruct” and “please” are set as “Keywords (Second retrieval condition)”. Further, according to the keyword information in FIG. 18, as the “Keywords (Additional keywords)”, “storage” and “place” are set in the information of which “Item number” is “1”, in addition to the information that is set in “Keywords (Second retrieval condition)”. Description on the other information included in FIG. 18 will be omitted.

Referring back to FIG. 8, the machine learning execution unit 112 performs machine learning of the second parameter 133 by providing the keywords extracted in the processing in S14 and the additional keywords included in the first teacher data 131 to the second identification function 135 (S15).

In concrete terms, the machine learning execution unit 112 specifies the keywords which are set in “Keywords (Second retrieval method)” of the information of which “Item number” is “1” in the keyword information described in FIG. 18, for example. The machine learning execution unit 112 also specifies keywords which are set in “Keywords (Additional keywords)” in the information of which “Item number” is “1” in the keyword information described in FIG. 18, for example. Then the machine learning execution unit 112 calculates the second parameter 133 by inputting each of the specified keywords to the second identification function 135 as the learning data, and performs machine learning of the calculated second parameter 133.

Then the machine learning execution unit 112 performs machine learning by calculating the second parameter 133 for the other information that is set in “Keywords (Second retrieval method)” of the keyword information in FIG. 18, and on the other information that is set in ‘Keywords (Additional keywords)” of the keyword information in FIG. 18.

In other words, the machine learning execution unit 112 adjusts the second parameter 133 every time the learning data is input to the second identification function 135, so that the second identification function 135 is established not only for the learning data which was input in the past, but also for the newly input learning data. Thereby the machine learning execution unit 112 can increase the accuracy of the second parameter 133 every time the learning data is input to the second identification function 135. An example of the second parameter 133 will be described later.

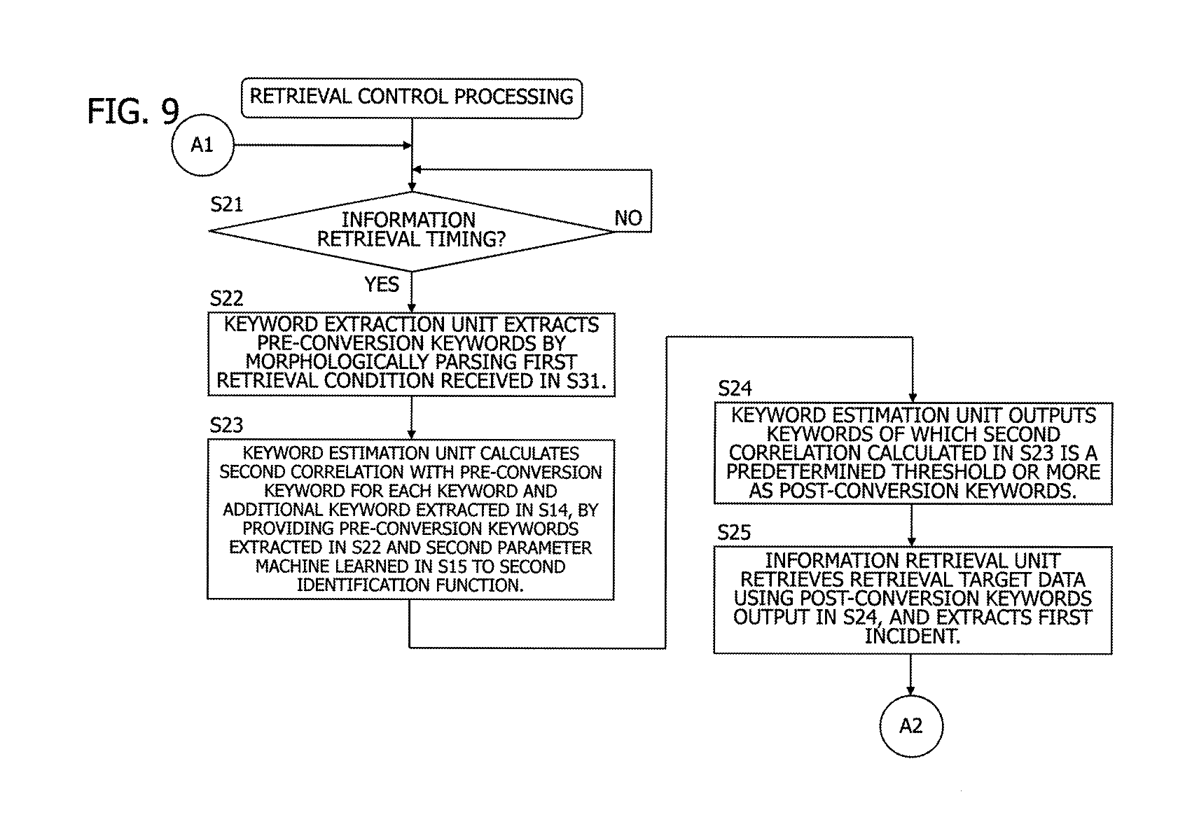

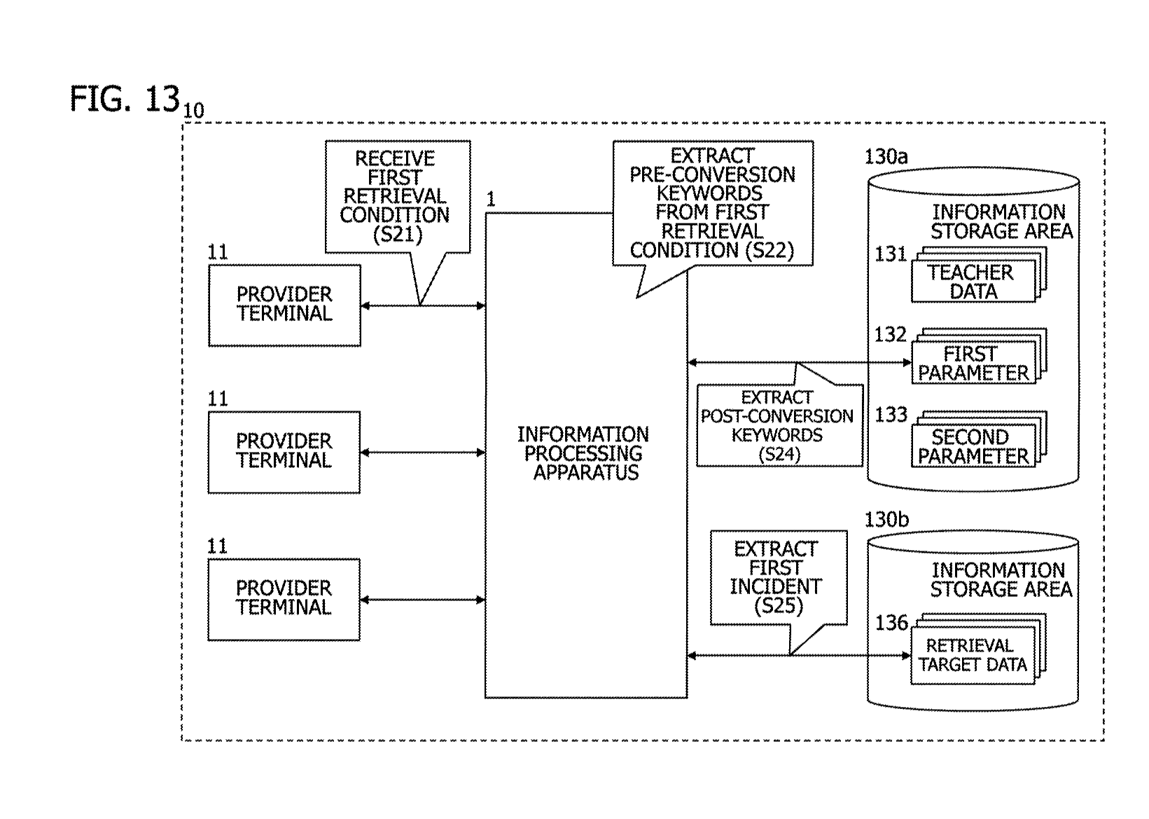

Referring back to FIG. 9, the information receiving unit 113 of the information processing apparatus 1 stands by until the information retrieval timing arrives (NO in S21). The information retrieval timing is, fore example, a timing when the first retrieval condition 141a is received from the provider terminal 11 (timing when the first retrieval condition 141a is input to the information processing apparatus 1). When the information retrieval timing arrives (YES in S21), the keyword extraction unit 111 extracts the pre-conversion keywords from the first retrieval condition 141a sent from the provider terminal 11 (S22), as depicted in FIG. 13. In concrete terms, the keyword extraction unit 111 extracts keywords by morphologically parsing the first retrieval condition 141a, for example. An example of the first retrieval condition 141a and the pre-conversion keywords will be described herein below.

[Example of First Retrieval Condition Sent from Provider Terminal]

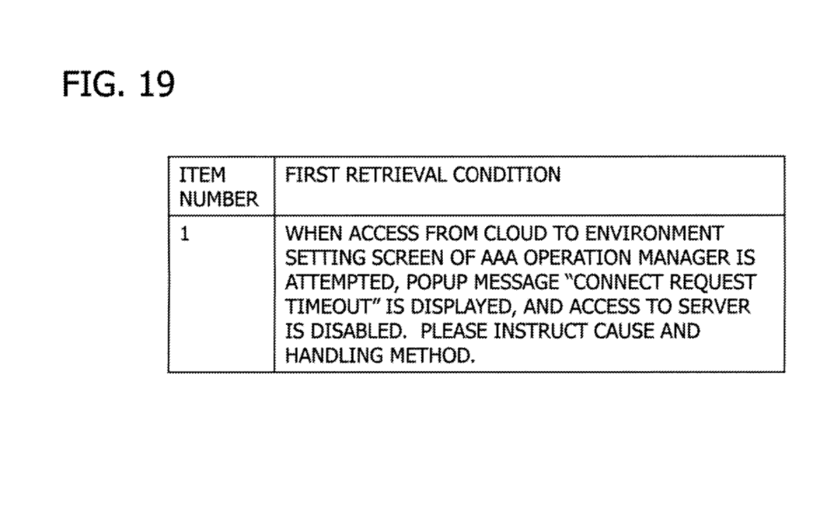

FIG. 19 is a table for describing an example of the first retrieval condition 141a sent from the provider terminal 11. As items, the first retrieval condition 141a in FIG. 19 has: “Item number” to identify each information included in the first retrieval condition 141a; and “First retrieval condition” in which the content of the first retrieval condition 141a is set.

In concrete terms, according to the first retrieval condition 141a in FIG. 19, sentences “When access from cloud to environment setting screen of AAA operation manager is attempted, popup message ‘connect request timeout’ is displayed, and access to server is disabled. Please instruct cause and handling method.” are set in “First retrieval condition” in the information of which “Item number” is “1”.

[Example of Pre-Conversion Keywords Extracted from First Retrieval Condition]

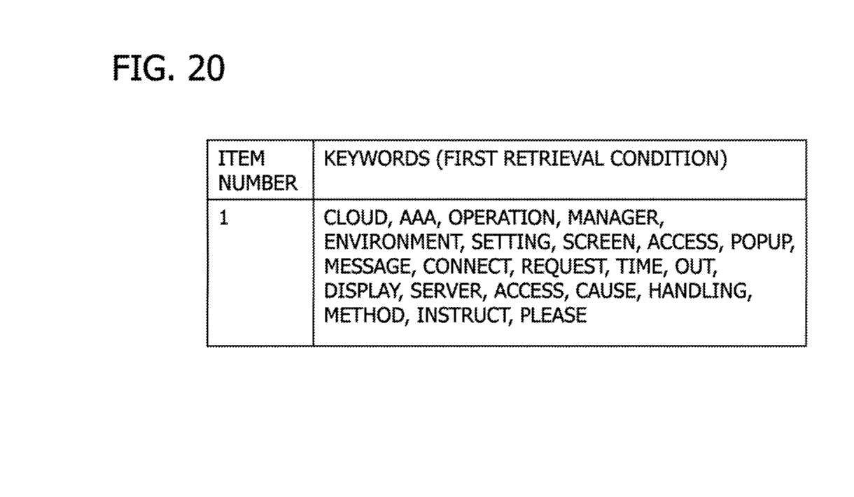

An example of pre-conversion keywords (hereafter also called pre-conversion keyword information) extracted from the first retrieval condition 141a sent from the provider terminal 11 will be described next. FIG. 20 is a table for describing an example of the pre-conversion keyword information.

As items, the pre-conversion keyword information in FIG. 20 has “Item number” to identify each information included in the pre-conversion keyword information in FIG. 20, and “Keywords (First retrieval condition)” in which keywords extracted from the first retrieval condition 141a are set.

In concrete terms, according to the pre-conversion keyword information in FIG. 20, in the information of which “Item number” is “1”, “cloud”, “AAA”, “operation”, “manager” and the like are set as “Keywords (First retrieval condition)”.

Referring back to FIG. 9, the keyword estimation unit 114 of the information processing apparatus 1 calculates the correlation with the pre-conversion keywords (hereafter also called second correlation information) extracted in the processing in S22 for each of the keywords extracted from the second retrieval condition 131a in the processing in S14 and the additional keywords 131d (S23).

In concrete terms, the keyword estimation unit 114 calculates the second correlation information with the pre-conversion keywords extracted in the processing in S22, by providing the pre-conversion keywords extracted in the processing in S22 and the second parameter 133 machine-learned in the processing in S15 to the second identification function 135. In other words, for each keyword of the keywords extracted from the second retrieval condition 131a in the processing in S14 and the additional keywords, the keyword estimation unit 114 calculates the second correlation information for determining whether each keyword is included in the post-conversion keywords. Examples of the second parameter 133 and the second correlation information will be described next.

[Example of Second Parameters]

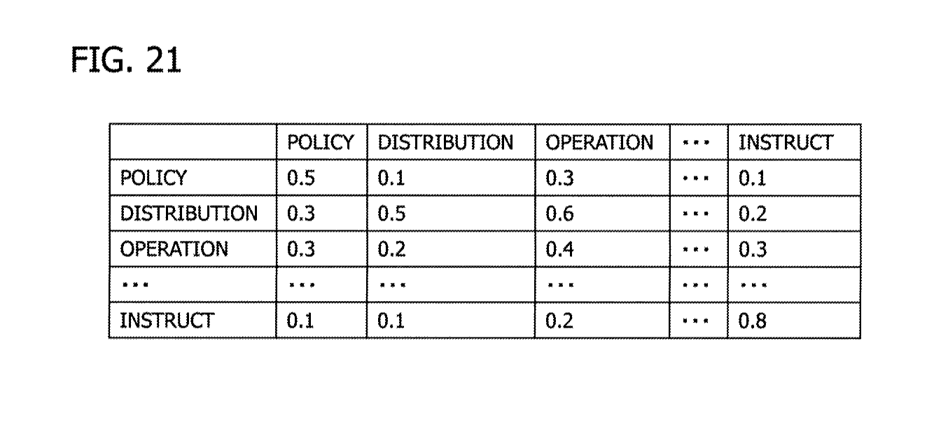

FIG. 21 is a table for describing an example of the second parameters 133. The second parameters 133 in FIG. 21 include a second parameter between each keyword of the keywords extracted from the second retrieval condition 131a in the processing in S14 and the additional keywords respectively. “policy”, “distribution”, “operation” and the like in the second parameters 133 in FIG. 21 correspond to each keyword of the keywords extracted from the second retrieval condition 131a in the processing in S14 and the additional keywords.

In concrete terms, if “policy” is included in the pre-conversion keywords extracted from the first retrieval condition 141a, the keyword estimation unit 114 refers to the information in the row where “policy” is set in the left column, out of the second parameters 133 in FIG. 21 in the processing in S23. In other words, in this case, the keyword estimation unit 114 refers to “0.5”, which is the information where “policy” is set, in the top row, “0.1” which is the information where “distribution” is set in the top row, “0.3” which is the information where “operation” is set in the top row and the like. Description on the other information included in FIG. 21 will be omitted.

[Example of Second Correlation Information]

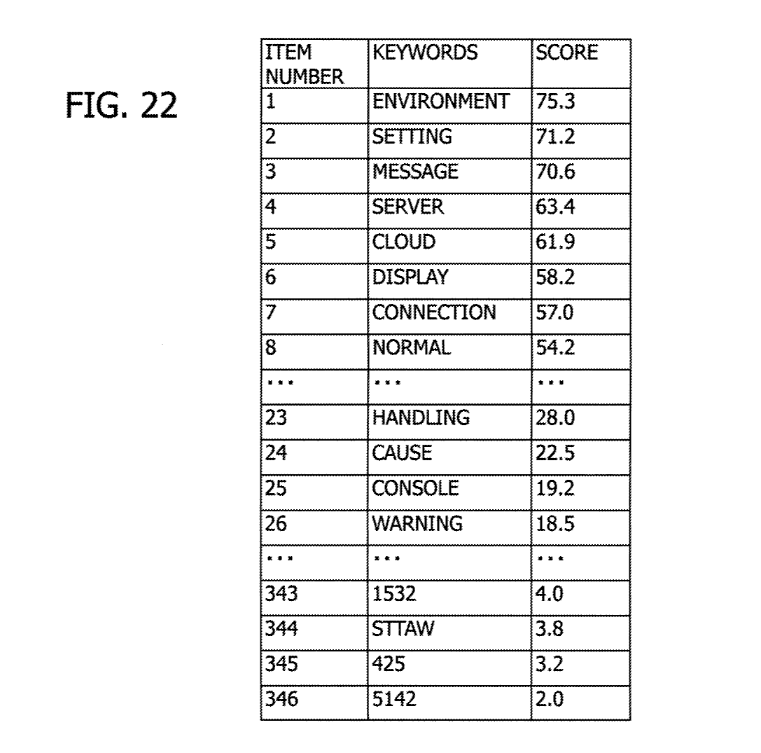

An example of the second correlation information will be described next. FIG. 22 is a table for describing an example of the second correlation information. As items, the second correlation information in FIG. 22 has: “Item number” to identify each information included in the second correlation information; “Keyword” to identify a keyword; and “Score” to indicate the second correlation information of each keyword. Each information included in the second correlation information in FIG. 22 will be described based on the assumption that the values are set in “Score” in descending order.

In concrete terms, if “policy” and “operation”, for example, are included in the pre-conversion keywords extracted from the first retrieval condition 141a, the keyword estimation unit 114 refers to the information in the rows where “policy” and “operation” are set in the left column, out of the information included in the second parameters 133 in FIG. 21. Therefore in the case of calculating the second correlation information to determine whether “distribution” is included in the post-conversion keywords, for example, the keyword estimation unit 114 refers to “0.1”, which is information where “policy” is set in the left column, and “distribution” is set in the top row. Further, in this case, the keyword estimation unit 114 refers to “0.2”, which is information where “operation” is set in the left column, and “distribution” is set in the top row. Then the keyword estimation unit 114 adds “0.1” and “0.2” which are referred information, for example, and multiplies this result by a predetermined coefficient, so as to calculate the second correlation information corresponding to “distribution”.

Then the keyword estimation unit 114 sets each second correlation information calculated for each word as listed in FIG. 22. In concrete terms, if the second correlation information calculated for “distribution” is “75.3”, for example, the keyword estimation unit 114 sets “75.3” in “Score” of the information of which “Keyword” is “distribution” (information of which “Item number” is “1”). Description on the other information included in FIG. 22 will be omitted.

Referring back to FIG. 9, the keyword estimation unit 114 outputs keywords, of which second correlation information calculated in the processing in S23 is a predetermined threshold or more, as the post-conversion keywords (S24). An example of the post-conversion keywords (hereafter also called post-conversion keyword information) will be described next.

[Example of Post-Conversion Keywords]

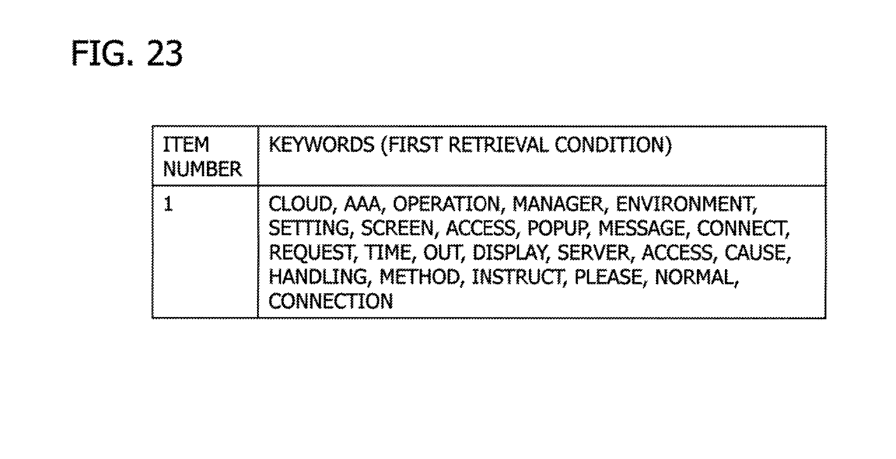

FIG. 23 is a table for describing an example of the post-conversion keywords. The post-conversion keyword information in FIG. 23 has the same items as the information in FIG. 20.

In concrete terms, if the predetermined threshold in the processing in S24 is “20.0”, the keyword estimation unit 114 specifies the information that is set in “Keywords” of the information of which “Item number” is “1” to “24”, for example, in the second correlation information in FIG. 22, as the post-conversion keywords. Therefore in this case, the keyword estimation unit 114 sets “cloud”, “AAA”, “operation”, “manager”, “normal”, “connection” and the like in the column of “Keywords (Retrieval condition)” as listed in FIG. 23.

In other words, in the second correlation information in FIG. 22, the information, which is set in “Keywords” of information of which “Item number” is “1” to “24”, includes “normal” and “connection” which are not included in “Keywords (First retrieval condition)” of the pre-conversion information described in FIG. 20. Therefore the keyword estimation unit 114 specifies “normal” and “connection” as well as the post-conversion keywords as listed in FIG. 23.

Thereby the information processing apparatus 1 can retrieve a more appropriate first incident 141b for the first retrieval condition 141a sent from the provider terminal 11.

Referring back to FIG. 9, the information retrieval unit 115 of the information processing apparatus 1 executes retrieval of the first incident 141b by using the post-conversion keywords output in the processing in S24 (S25). An example of the first incident 141b retrieved in the processing in S25 will be described next.

[Example of First Incidents Retrieved in Processing in S25]

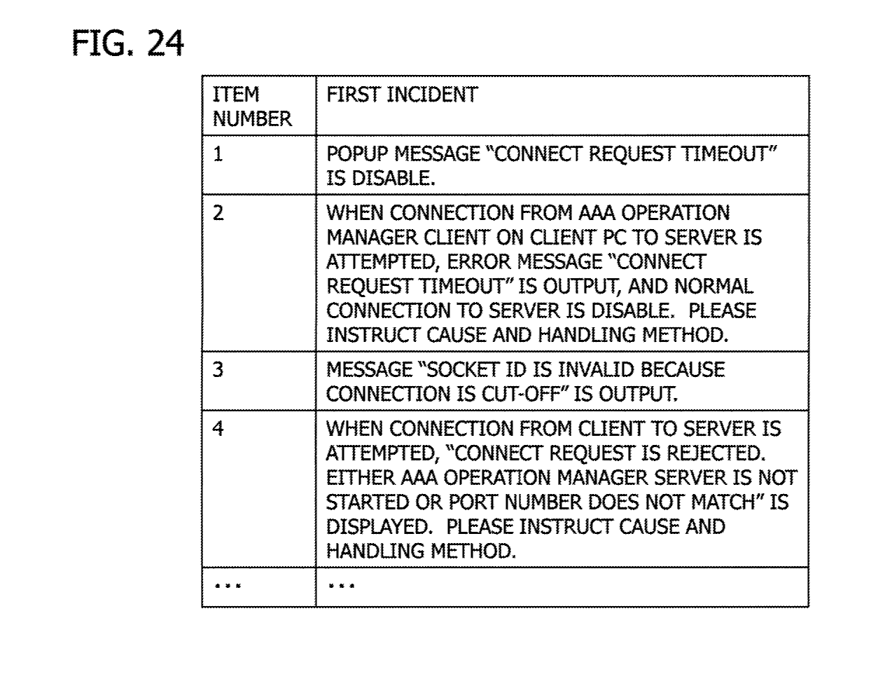

FIG. 24 is a table for describing an example of the first incidents 141b retrieved in the processing in S25. As items, the first incidents 141b in FIG. 24 have: “Item number” to identify each information included in the first incident 141b; and “First incident” in which the first incident 141b retrieved in the processing in S25 is set.

In concrete terms, according to the first incidents 141b in FIG. 24, “popup message ‘connect request timeout’ is displayed” is set in the “First incident” in the information of which “Item number” is “1”. Description on the other information included in FIG. 24 will be omitted.

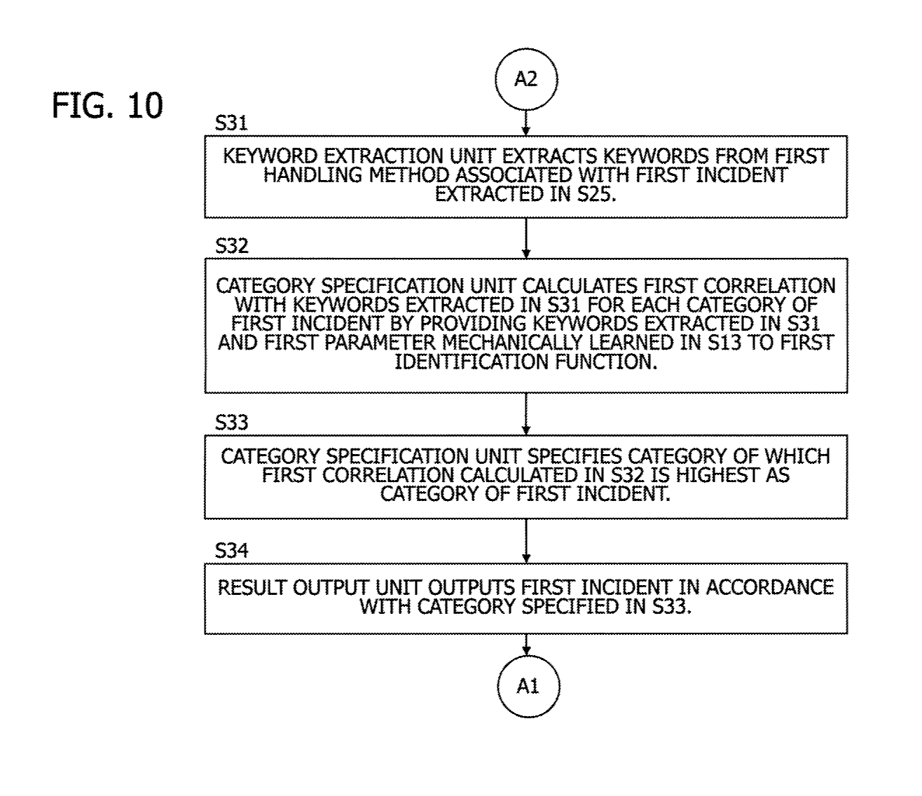

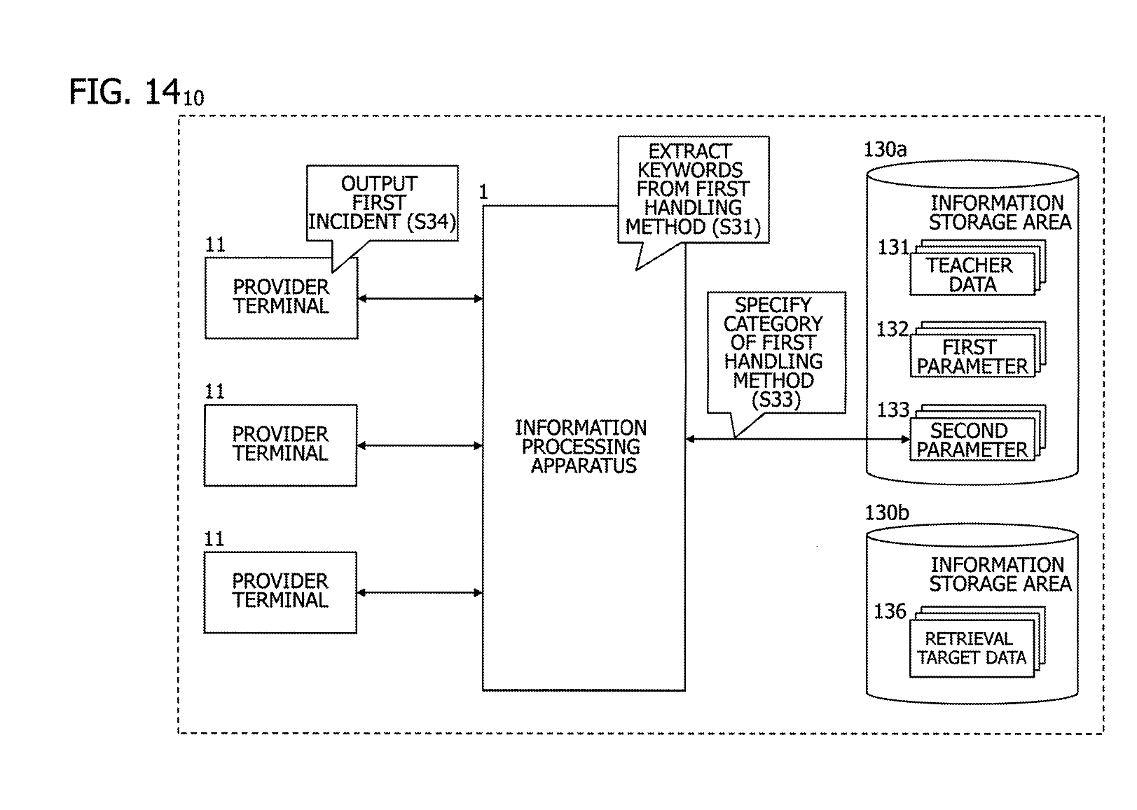

Referring back to FIG. 10, the keyword extraction unit 111 extracts keywords from the first handling method 141c associated with the first incident 141b extracted in the processing in S25 (S31), as depicted in FIG. 14. In concrete terms, the keyword extraction unit 111 refers to the retrieval target data 136 stored in the information storage area 130, and extracts the keywords from the first handling method 141c associated with the first incident 141b extracted in the processing in S25. Examples of the retrieval target data 136, the first handling method 141c associated with the first incident 141b extracted in the processing in S25, and the keywords extracted from the first handling method 141c will be described next.

[Example of Retrieval Target Data]

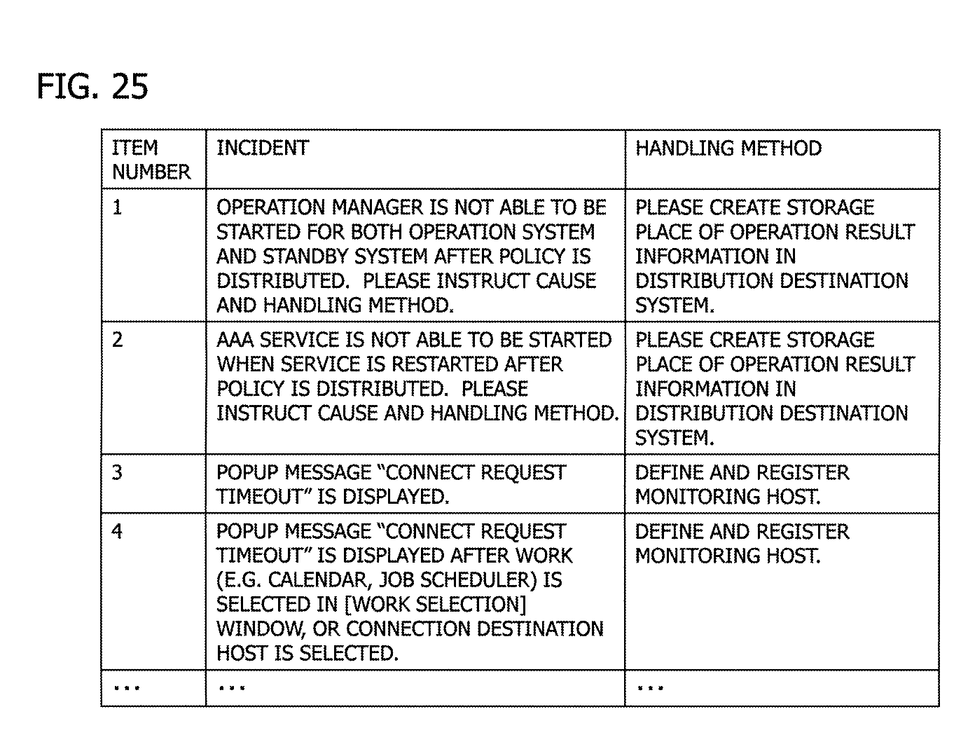

FIG. 25 is a table for describing an example of the retrieval target data 136. As items, the retrieval target data 136 in FIG. 25 has: “Item number” to identify each information included in the retrieval target data 136; “Incident” in which the incident is set; and “Handling method” in which a handling method is set. The retrieval target data 136 may include the second incident 131b and the second handling method 131c.

In concrete terms, according to the retrieval target data 136 in FIG. 25, “Operation manager is not able to be started for both operation system and standby system after policy is distributed. Please instruct cause and handling method.” is set as “Incident” in the information of which “Item number” is “1”. Further, according to the retrieval target data 136 in FIG. 25, “Please create storage place of operation result information in distribution destination system.” is set as “Handling method” in the information of which “Item number” is “1”. Description on the other information included in FIG. 25 will be omitted.

[Example of First Handling Method]

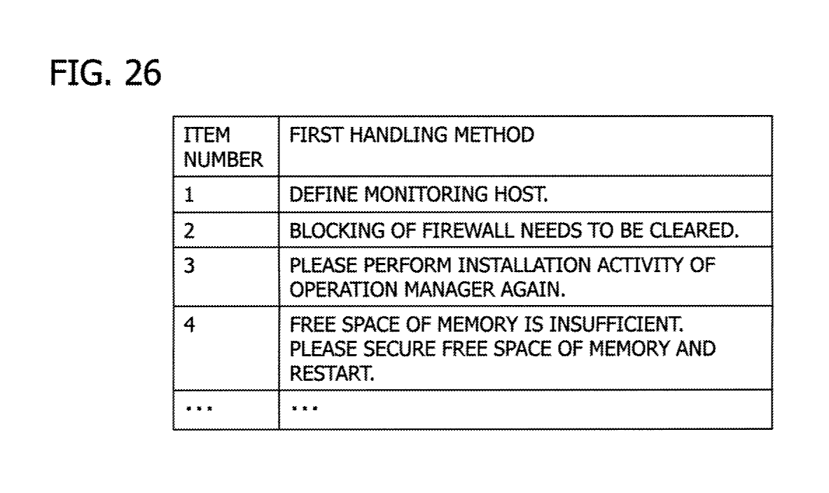

An example of the first handling method 141c associated with the first incident 141b extracted in the processing in S25 will be described next. FIG. 26 is a table for describing an example of the first handling method 141c associated with the first incident 141b extracted in the processing in S25.

As items, the first handling method 141c in FIG. 26 has “Item number” to identify each information included in the first handling method 141c; and “First handling method” in which the first handling method 141c corresponding to the first incident 141b retrieved in the processing in S25 is set.

In concrete terms, according to the first handling method 141c in FIG. 26, “Please define monitoring host.” is set as the “First handling method” in the information of which “Item number” is “1”. In other words, the information that is set in the “First incident” of the information of which “Item number” is “1” in the first incidents 141b described in FIG. 24 is the same as the information that is set in the “Incident” of the information of which “Item number” is “3” in the retrieval target data 136 described in FIG. 25. Therefore in the processing in S31, the keyword extraction unit 111 specifies the information that is set in the “Handling method” of the information of which “Item number” is “3” in the retrieval target data 136 in FIG. 25, for the information of which “Item number” is “1” in the first incidents 141b in FIG. 24. Then the keyword extraction unit 111 sets the specified information in the information of which “Item number” is “1” in the first handling methods 141c in FIG. 26. Description on the other information included in FIG. 26 will be omitted.

[Example of Keywords Extracted from First Handling Methods]

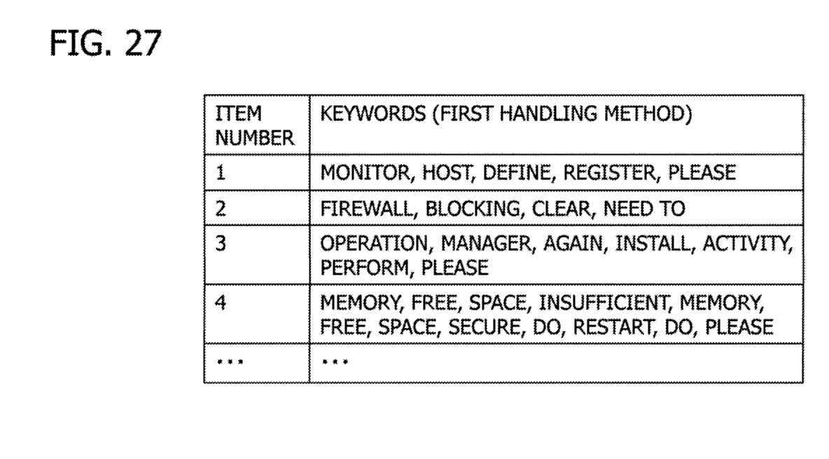

An example of the keywords extracted from the first handling methods 141c described in FIG. 26 will be described next. FIG. 27 is a table for describing an example of keywords extracted from the first handling method 141c. As items, the first handling methods 141c in FIG. 27 has: “Item number” to identify each information included in the first handling methods 141c; and “Keywords (First handling method)” in which keywords extracted from the first handling method 141c are set.

For example, in the keyword information in FIG. 27, “monitor”, “host”, “define”, “register” and “please” are set as “Keywords (First handling method)” in the information of which “Item number” is “1”. Description on the other information included in FIG. 27 will be omitted.

Referring back to FIG. 10, the category specification unit 116 of the information processing apparatus 1 calculates correlation with the keywords extracted in the processing in S31 (hereafter also called first correlation information) for each category of the first incident 141b (S32).

In concrete terms, the category specification unit 116 calculates the first correlation information with the keywords extracted in the processing in S31 by providing the keywords extracted in the processing in S31 and the first parameter 132 machine-learned in the processing in S13 to the first identification function 134. In other words, the category specification unit 116 calculates the first correlation information to determine the category of the first incident 141b extracted in the processing in S25. Examples of the first parameters 132 and the first correlation information will be described.

[Example of First Parameters]

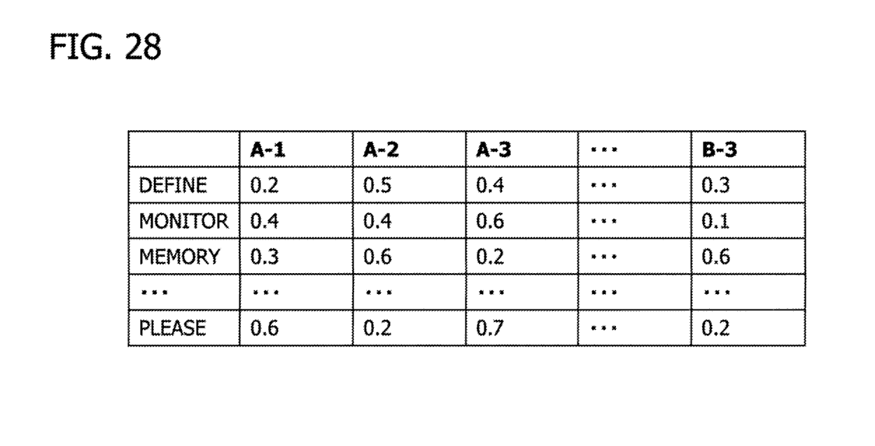

FIG. 28 is a table for describing an example of the first parameters 132. The first parameters 132 in FIG. 28 include each first parameter in the relationship between each keyword extracted from the second handling method 131c, and each category of the second incident 131b. The information that is set in the left column (e.g. “define”, “monitor”, “memory”) in the first parameters 132 in FIG. 28 corresponds to each keyword extracted from the second handling method 131c in the processing in S12. The information that is set in the top row (e.g. “A-1”, “A-2”, “A-3”) in the first parameters 132 in FIG. 28 corresponds to the information indicating each category of the first incident 132b.

In concrete terms, if “define” is included in the keywords extracted from the first handling method 141c in the processing in S31, the category specification unit 116 refers to the information in the row where “define” is set in the left column, out of the first parameters 132 in FIG. 28 in the processing in S32. In other words, in this case, the category specification unit 116 refers to, for example, “0.2” which is information where “A-1” is set in the top row, “0.5” which is information where “A-2” is set in the top row in the column, and “0.4” which is information where “A-3” is set in the top row in the column. Description on the other information included in FIG. 28 will be omitted.

[Example of First Correlation Information]

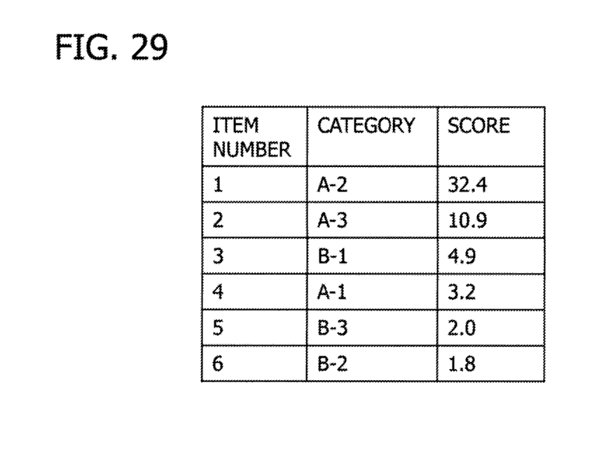

An example of the first correlation information of one first incident 141b, out of the first incidents 141b extracted in the processing in S25, will be described next. FIG. 29 is a table for describing an example of the first correlation information. As items, the first correlation information in FIG. 29 has: “Item number” to identify each information included in the first correlation information; “Category” to identify each category; and “Score” to indicate the first correlation information of each keyword. Each information included in the first correlation information in FIG. 29 will be described based on the assumption that the values are set in “Score” in descending order.

In concrete terms, if “define” and “memory” are included in the keywords extracted from the first handling method 141c, the category specification unit 116 refers to the information in the rows where “define” and “memory” are set in the left column, out of the information included in the first parameters 132 in FIG. 28. Therefore in the case of, for example, determining whether the category of the first incident 141b corresponding to the first handling method 141c including “define” and “memory” is “A-1”, the category specification unit 116 refers to “0.2” which is information where “define” is set in the left column and “A-1” is set in the top row. Further, in this case, the category specification unit 116 refers to “0.3” which is information where “memory” is set in the left column and “A-1” is set in the top row. Then the category specification unit 116 adds “0.2” and “0.3” which are referred information, for example, and multiplies this result by a predetermined coefficient, so as to calculate the first correlation information corresponding to “A-1”.

Then the category specification unit 116 sets each first correlation information calculated for each keyword as listed in FIG. 29. In concrete terms, if the first correlation information calculated for “A-1” is “3.2”, for example, the category specification unit 116 sets “3.2” in “Score” of the information of which “Keyword” is “A-1” (information of which “Item number” is “4”). Description on the other information included in FIG. 29 will be omitted.

Referring back to FIG. 10, the category specification unit 116 specifies a category, of which second correlation information calculated in the processing in S32 is highest, as the category of the first incident 141b (S33). In other words, the category specification unit 116 specifies “A-2” as the category of the first incident 141b corresponding to the first correlation information described in FIG. 29, for example.

Then the result output unit 117 of the information processing apparatus 1 outputs the first incident in accordance with the category specified in the processing in S33 (S34). In concrete terms, the result output unit 117 sends the first incident 141b extracted in the processing in S25 to the provider terminal 11, along with the information on the category specified in the processing in S33, for example. Then the provider terminal 11 outputs the first incident 141b, extracted in the processing in S25, to the output apparatus 21 in accordance with the category specified in the processing in S33, for example. An example of the output apparatus 21, in the state of outputting the first incidents 141b, will be described next.

[Example of State of Outputting First Incidents 141b]

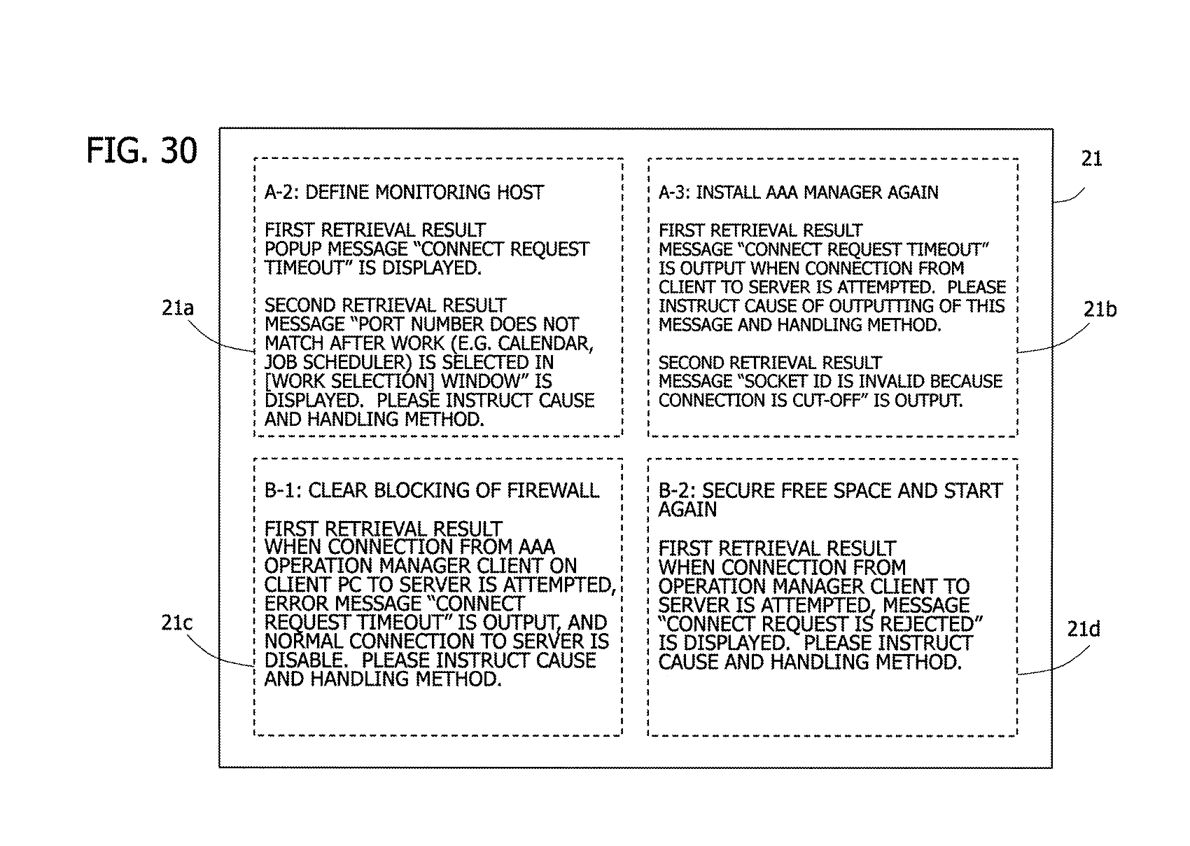

FIG. 30 is an example of the output apparatus 21 in the state of outputting the first incidents 141b. In the output apparatus 21 in FIG. 30, the first incidents 141b are separately displayed in a first display unit 21a, a second display unit 21b, a third display unit 21c, and a fourth display unit 21d.

In the example in FIG. 30, the first incident 141b of which second correlation information is “A-2” is displayed in the first display unit 21a, and the first incident 141b of which second correlation information is “A-3” is displayed in the second display unit 21b. Further, in the example in FIG. 30, the first incident 141b of which second correlation information is “B-1” is displayed in the third display unit 21c, and the first incident 141b of which second correlation information is “B-2” is displayed in the fourth display unit 21d.

In concrete terms, in the case of the first incident 141b described in FIG. 29, the category of which second correlation information is highest is “A-2”. Therefore the first incident 141b described in FIG. 29 is output to the first display unit 21a as “First retrial result” as depicted in FIG. 30. Description on the other information included in FIG. 30 will be omitted.

Thereby the provider is enabled to access the first incident 141b, which is in the state of being categorized in accordance with the content, in the provider terminal 11. As a result, the provider can easily specify the first incident 141b which is used for retrieving the first handling method 141c.

After the processing in S34, the provider specifies the first incident 141b used for retrieving the first handling method 141c, from the first incidents 141b output in the processing in S34, for example. In other words, the provider specifies the first incident 141b of which content is closest to the first retrieval condition 141a received by the information receiving unit 113.

Then the information retrieval unit 115 refers to the retrieval target data 136 stored in the information storage area 130, for example, and extracts the first handling method 141c corresponding to the first incident 141b specified by the provider. Then the result output unit 117 sends the extracted first handling method 141c to the provider terminal 11.

Thereby the provider terminal 11 is enabled to output the first handling method 141c, received from the information processing apparatus 1, to the output apparatus in which the user can access information, for example. Therefore the user can access the first handling method 141c corresponding to the first retrieval condition 141a.

If the category of the first incident 141b specified in the processing in S33 is corrected by the provider, the machine learning execution unit 112 may perform the machine learning of the first parameters 132 again. In this case, the machine learning execution unit 112 performs the machine learning of the first parameters 132 again by providing the keywords extracted from the first handling method 141c in the processing in S31 and the category of the first incident 141b corrected by the provider to the first identification function 134, for example. Thereby the provider can further increase the accuracy of the first parameters 132.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing therein a retrieval control program that causes a computer to execute a process comprising:
receiving a retrieval condition;
extracting an incident corresponding to the received retrieval condition from a storage that stores an incident in association with a handling method;
classifying the extracted incident in accordance with the handling method associated with the extracted incident and;
outputting the classified incident as a retrieval result.

2. The non-transitory computer-readable storage medium storing therein a retrieval control program according to claim 1, the program that causes the computer to execute the process further comprising:
based on keywords extracted from a learning handling method included in teacher data, machine-learning a classification parameter to classify, into a plurality of categories, a learning incident included in the teacher data associated with the learning handling method, wherein
the outputting includes:
specifying the category of the extracted incident based on the keywords extracted from the handling method associated with the extracted incident by using the machine-learned classification parameter, and
outputting the extracted incident for each of the plurality of categories.

3. The non-transitory computer-readable storage medium storing therein a retrieval control program according to claim 2, wherein
the machine-learning includes:
machine-learning the classification parameter by using, as learning data, the keywords extracted from the learning handling method and the category of the learning incident.

4. The non-transitory computer-readable storage medium storing therein a retrieval control program according to claim 2, wherein
the specifying includes:
calculating correlation with the keywords extracted from the handling method for each of the plurality of categories by using the machine-learned classification parameter, and
specifying the category of which the calculated correlation is highest as the category of the incident.

5. The non-transitory computer-readable storage medium storing therein a retrieval control program according to claim 1, the program that causes the computer to execute the process further comprising:
machine-learning an additional parameter to convert the keywords extracted from a learning retrieval condition included in teacher data, wherein
the extracting includes:
extracting the incident by using post-conversion keywords acquired by converting, based on the machine-learned additional parameter, pre-conversion keywords extracted from the retrieval condition.

6. The non-transitory computer-readable storage medium storing therein a retrieval control program according to claim 5, wherein
the machine-learning includes:
machine-learning the additional parameter by using, as learning data, the keywords extracted from the learning retrieval condition and additional keywords included in the teacher data corresponding to the learning retrieval condition.

7. The non-transitory computer-readable storage medium storing therein a retrieval control program according to claim 5, wherein
the extracting includes:
calculating correlation with the pre-conversion keywords for each of the keywords extracted from the learning retrieval condition and for each of the additional keywords, by using the machine-learned additional parameter, and
specifying keywords of which the calculated correlation is a predetermined threshold or more as the post-conversion keywords.

8. A retrieval control apparatus that receives a retrieval condition, the retrieval control apparatus comprising:
a processor configured to:
extract an incident corresponding to the received retrieval condition from a storage that stores an incident in association with a handling method;
classify the extracted incident in accordance with the handling method associated with the extracted incident; and
output the classified incident as a retrieval result.

9. The retrieval control apparatus according to claim 8, wherein
a processor configured to:
machine-learn, based on keywords extracted from a learning handling method included in teacher data, a classification parameter to classify, into a plurality of categories, a learning incident included in the teacher data associated with the learning handling method,
specify the category of the extracted incident based on the keywords extracted from the handling method associated with the extracted incident by using the machine-learned classification parameter, and
output the extracted incident for each of the plurality of categories.

10. A retrieval control method, comprising:
receiving, by a processor, a retrieval condition;
extracting, by a processor, an incident corresponding to the received retrieval condition from a storage that stores an incident in association with a handling method;
classifying, by a processor, the extracted incident in accordance with the handling method associated with the extracted incident; and
outputting, by a processor, the classified incident as a retrieval result.

11. The retrieval control method according to claim 10, further comprising:
based on keywords extracted from a learning handling method included in teacher data, machine-learning, by a processor, a classification parameter to classify, into a plurality of categories, a learning incident included in the teacher data associated with the learning handling method, wherein
the outputting includes:
specifying the category of the extracted incident based on the keywords extracted from the handling method associated with the extracted incident by using the machine-learned classification parameter, and
outputting the extracted incident for each of the plurality of categories.
